(19) United States
(12) Patent Application Publication
(10) Pub. No.: US 2025/0214905 A1
(43) Pub. Date: Jul. 3, 2025

(54) PHOSPHATE-ENRICHED, HEAVY-METAL DEPLETED GRANULAR FERTILIZER, METHOD OF PRODUCTION, DEVICE AND USE

(71) Applicant: Pontes Pabuli GmbH, Leipzig (DE)

(72) Inventor: Frank Thoralf Hager, Leipzig (DE)

(73) Assignee: Pontes Pabuli GmbH, Leipzig (DE)

(21) Appl. No.: 18/847,811

(22) PCT Filed: Mar. 16, 2023
(86) PCT No.: PCT/EP2023/056711

§ 371 Date: Sep. 17, 2024

(30) Foreign Application Priority Data
Mar. 17, 2022 (DE) 102022106256.2
Apr. 4, 2022 (EP) 22166485.7

(51) Int. Cl. C05B 19/00; C05B 17/00; C05G 5/12

(52) U.S. Cl. CPC C05B 19/00; C05B 17/00; C05G 5/12

(57) ABSTRACT

A phosphate-enriched, heavy metal-depleted fertilizer granulate includes at least one inorganic secondary phosphate, which is produced by a two-stream process, wherein a raw material dispersion is fed to process stream A and process stream B, in which this raw material dispersion either is produced in process step a) from at least one inorganic secondary phosphate and at least one reactant and this produced raw material dispersion is fed divided to process stream A and B or in process step a′) the inorganic secondary phosphate is first divided, are produced separately from one another and these separately produced raw material dispersions are fed to process stream A and B. The proportion of a liquid phase is greater than 30% and the incubation time between inorganic secondary phosphate and reactant is between 1 to 100 minutes.

The invention relates to a phosphate-enriched, heavy metal-depleted fertilizer granulate which can be used for nutrient supply in agriculture, forestry and/or horticulture, as well as a manufacturing process therefor and an apparatus for its manufacture.

### STATE OF THE ART

The thermal utilization of these organic residues is currently becoming increasingly important. Ashes from the thermal utilization and/or incineration of organic residues are often suitable sources of raw materials due to their high content of nutrients such as phosphorus (P). Due to the high incineration temperatures, the nutrient components such as phosphorus are usually in a form that is not readily available to plants. In addition, heavy metals are also concentrated during incineration. Due to the poor plant availability of the phosphorus (P) contained in the ashes and the pollutant content, direct use of the ashes as fertilizer is hardly possible. For this reason, such ashes are currently mostly landfilled or used in landscaping and are therefore no longer available to the material cycles as a source of raw materials.

Various processes for recycling phosphorus-containing incineration residues, such as from sewage sludge, are known in the state of the art. The known processes are based on the raw material ash, whereby the phosphate content (P content) in the ash should be as high as possible. The processes for recovering phosphate from sewage sludge ash can generally be divided into thermochemical, thermoelectric and wet-chemical approaches.

Numerous different concepts are pursued in the wet chemical processes, whereby a general distinction is made between processes in which phosphorus is extracted from the ash and thus brought into the liquid phase (leaching process) and processes in which the acid is mixed with the ash, thereby making the insoluble phosphate available to plants and producing a fertilizer from this overall mixture (phosphate conversion process).

Leaching processes, such as BioCon, SEPHOS, SESALPhos, Tetraphos, PASCH or Leachphos processes, are based on using a solvent to dissolve the phosphorus from the combustion residue as selectively as possible and separating this phosphorus-containing solution from the insoluble residue. The resulting phosphorus-containing solution is then purified from accompanying components and converted into a secondary phosphate product (e.g. Ca-phosphate, phosphoric acid). The processes differ from one another in terms of the solvents and precipitants used for phosphate separation, the recycling product and the type of heavy metal separation. The advantage of these processes is that only some of the heavy metals in the incineration residue are dissolved by the solvent. The dissolved heavy metals and the dissolved accompanying components are then largely selectively separated from the phosphate-containing solution over several purification stages. This results in a phosphate-containing product with a low heavy metal concentration that is as free as possible from accompanying components. The aim is to achieve a particularly high product and grade purity because it is to be used or further processed as a chemical product. In principle, there are various fields of application for the products obtained from these processes. However, the only practical use of these products is often as an intermediate product for the fertilizer industry. The products are generally too expensive for use in the fertilizer industry compared to conventionally produced fertilizers. One reason for this is that a very high proportion of residue from the dissolving process (insoluble residue) remains as waste, which is expensive to dispose of. In addition, the aim of separating the accompanying components as completely as possible is usually a multi-stage and therefore very complex and expensive process, as the phosphate-rich product is usually intended to achieve a high level of product purity for the intended fields of application. These processes attempt to dissolve the phosphate as selectively as possible from the phosphate-containing combustion residue, as co-dissolved accompanying components must then be separated at great expense in order to obtain a product that is as phase-pure as possible. This means that the undissolved proportion that remains as waste from the processes is very high, typically equal to or more than 50% of the phosphate-containing incineration ash used. This high proportion of waste from these processes is not only disadvantageous for sustainability reasons, but also contains nutrients and trace elements (e.g. Mg, K, S) that are useful for plant nutrition and growth or for soil properties (e.g. air permeability, water storage capacity) as a basis for good yields (e.g. aluminates, silicates). These processes leave them unused as waste in the undissolved residue.

A different approach is taken by processes that specifically make the phosphate phase available to plants and largely convert the entire phosphate-containing combustion residue into a fertilizer (phosphate conversion process). For this purpose, a solvent (usually mineral acid) reacts with a phosphate-containing combustion residue and dissolves the poorly plant-available phosphate phase from the combustion residue. Unlike the leaching process, however, the phosphate-containing solution is not subsequently separated from the undissolved residue, but the entire mixture is transferred to a fertilizer. The advantage of this process is that there is no insoluble residue, which is usually expensive to dispose of. These processes are also simpler and less complex in terms of process engineering. As a result, these processes are generally much more cost-effective and sustainable than leaching processes. DE 10 2010 034 042 B4 is an example of such a process.

In some embodiments of this type of phosphate conversion process, some of the heavy metals can be separated, for example in WO 2019/149405 A1. The fundamental disadvantage here is that only the heavy metals that were previously dissolved from the phosphate-containing combustion residue into the liquid phase by the reactant can be separated. This is problematic because the heavy metals are bound to different phases in the phosphate-containing combustion residue and these phases are dissolved to different degrees by the reactant. Heavy metals that are bound to the insoluble residue (for example, typically Pb, Zn, Ni in particular) cannot be separated or can only be separated to a very small extent. This means that phosphate-containing incineration residues with this type of bound heavy metals cannot be converted into fertilizer in accordance with the Fertilizer Ordinance using this process and are therefore not usable.

A further disadvantage of these processes (phosphate conversion processes) is that the phosphate content of the fertilizers produced, which comes from the phosphate-containing combustion residue, is relatively low. This is due to the fact that the phosphate-containing incineration residue is treated with the solvent and both are transferred into the fertilizer product, resulting in a reduction (dilution) of the percentage of phosphate from the phosphate-containing incineration residue. If, for example, a sewage sludge ash contains 15% P₂O₅ as phosphate-containing incineration residue, this proportion is reduced by the addition of the reactant and a fertilizer with significantly less than 15% P₂O₅ is formed. However, potential users or processors of such fertilizers, such as farmers or fertilizer manufacturers, often require high-phosphate phosphate fertilizers such as at least “superphosphate” (approx. 18% P₂O₅), double superphosphate (approx. 35% P₂O₅) or better triple superphosphate (46% P₂O₅), as their use in agriculture or as a basic component for the production of complex fertilizers is more efficient and simpler. These high-phosphate fertilizers cannot be produced with these processes using sewage sludge ash as an example.

These processes offer the possibility of either using a phosphate-containing solvent (e.g. phosphoric acid) or adding phosphate-containing nutrient components (e.g. monoammonium phosphate (MAP)), which increases the phosphate content in the fertilizer. However, these phosphate-containing solvents or nutrient components are expensive and very dependent on a highly volatile world market.

Moreover, these additionally added phosphate-containing solvents or nutrient components then come from conventional production. In other words, the raw material used for their production is rock phosphate, which has been extracted from deposits and processed accordingly using the established digestion methods of the fertilizer industry. By adding such conventional phosphate-containing solvents or nutrient components, the fertilizers produced lose their status as pure phosphate recyclate, as the phosphate no longer originates solely from recycling, but has in part been conventionally extracted from mined rock phosphates. However, as the mining and processing of rock phosphate has harmful and invasive consequences for the environment, is energy-intensive and incurs high transport costs, users with high sustainability standards, such as organic farmers, want to avoid the use of conventional phosphate fertilizers, which are therefore not permitted there. Phosphate conversion processes, as known from WO 2019/149405 A1, therefore do not offer the possibility of producing pure phosphate-recycled fertilizers with a phosphate content greater than the incineration residue used without the addition of conventional phosphate-containing solvents or phosphate-containing nutrient components, which means that this agricultural segment is accordingly not served with high-percentage phosphate fertilizers.

In EP 3 037 396 A1, ash or a charring residue is also mixed with a mineral acid. This involves going through various process steps, which ultimately results in a moist filter cake that can be further processed and, according to the specification, used as a fertilizer in agriculture.

Consequently, this process produces a filter cake whose phosphate concentration is lower than the phosphate-containing ash or carbonization residue used due to the digestion and mixing with the acid. EP 3 037 396 A1 does not disclose any way of producing a phosphate-concentrated filter cake with a higher phosphate content than the phosphate-containing incineration residue used, in particular no concentrated pure phosphate cyclate without the addition of conventional phosphate components such as phosphoric acid or phosphate salts).

The process can also be used to separate heavy metals from the solution separated from vessel 2. This means that, at best, the heavy metals that are dissolved in this solution can be separated. Heavy metals that are not dissolved by the reactant (solvent) can therefore not be separated. In order for them to be separated in the separated solution, the heavy metals must first be transferred into solution, which can be done by the mineral acid used. However, it remains unclear whether this should actually take place, as it is specified as a special feature of the process that the mineral acid in the first vessel absorbs heavy metal ions and phosphate at the beginning of the process, but becomes increasingly saturated with phosphate and heavy metal ions as the process progresses. As a result, no further phosphate and no further heavy metal ions from the ash or the carbonization residue dissolve in the acid.

This special feature of the process described also does not appear to be suitable for converting poorly soluble phosphate in combustion residues into more soluble phosphate, i.e. making it available to plants. This requires an acid digestion similar to that of rock phosphate. However, if no further phosphate is dissolved in the acid in the first vessel and no further acid is added as a reactant in the subsequent batch, no conversion can take place. The phosphate remains unchanged, and with it the poor solubility.

### PURPOSE OF THE INVENTION

In view of the state of the art, the invention is based, on the one hand, on the task of providing improved phosphate-enriched and heavy metal-reduced fertilizer granules which optimize the pedosphere with regard to soil flora and soil fauna, whereby this phosphate enrichment results from a concentration of the phosphate content from the inorganic secondary phosphate (e.g. phosphate-containing ash), only small amounts of waste are produced and heavy metals as a whole and, in particular, the heavy metals which are only slightly soluble in the solvent are separated in an improved manner. This phosphate enrichment results from a concentration of the phosphate content from the inorganic secondary phosphate (e.g. phosphate-containing ash), only small amounts of waste are produced and heavy metals as a whole, and in particular the heavy metals that are only slightly soluble in the solvent, are separated more effectively. Soil flora consists mainly of plant or non-animal organisms, such as bacteria, ray fungi, fungi, algae and lichens. The soil fauna is made up of animal unicellular and multicellular organisms, which are differentiated according to their size into microfauna (<0.2 mm; e.g. ciliates, flagellates, amoebae, small nematodes), mesofauna (<2 mm; e.g. springtails, rotifers) and mesofauna (<2 mm; e.g. brittleworms, barnacles). e.g. springtails, rotifers, mites), macrofauna (>2 mm; e.g. bristle worms, woodlice, insects) and megafauna (>20 mm; e.g. vertebrates such as voles, shrews, moles). The optimization (improvement) mainly concerns the improved plant growth, as well as the growth of bacteria, flagellates, nematodes, annelids or insects and others.

In particular, the phosphate enrichment is intended to enable a high-phosphate-rich, purely recycled phosphate fertilizer to be formed by concentrating the phosphate content from the inorganic secondary phosphate without adding conventional (conventionally obtained) phosphate components such as phosphoric acid or phosphate salts, i.e. a pure phosphate recyclate.

The present invention is also based on the task of providing an economical, ecological, flexible, simple and technically feasible process for the production of soil- and/or plant-specific fertilizers with precisely adjustable nutrient composition in granular form.

The method according to the invention should make it possible to process a wide variety of inorganic secondary phosphates efficiently and cost-effectively, whereby soil- and plant-specific fertilizer compositions should also be provided in a targeted manner, whereby a large part of the concentrated phosphate should be present in the resulting fertilizer granulate in a form that is readily available to plants and at least some of the heavy metals are separated. In addition, a fertilizer is to be provided which can be used and/or applied in agriculture, forestry or horticulture as a pediculicide.

### SPECIFICATION OF THE INVENTION

The task is solved by the features of the independent claims. Advantageous embodiments of the invention are specified in the dependent claims.

According to the invention, a phosphate-enriched, heavy metal-depleted fertilizer granulate is provided which can be produced from at least one inorganic secondary phosphate and is produced by a two-stream process, wherein a raw material dispersion is fed to process stream A and process stream B, in which this raw material dispersion either is produced in process step a) from at least one inorganic secondary phosphate and at least one reactant and this produced raw material dispersion is fed divided to process stream A and B or in process step a, a′) the inorganic secondary phosphate is first divided, two raw material dispersions (each comprising a partial amount of the at least one inorganic secondary phosphate and at least one reactant) are produced separately from one another and these separately produced raw material dispersions are fed to process streams A and B, wherein the proportion of a liquid phase in the raw material dispersion is greater than 30% and the incubation time between inorganic secondary phosphate and reactant is between 1 to 100 minutes, wherein the process stream A comprises the following process steps,
Addition of a heavy metal precipitation agent during the preparation of the raw material dispersion and/or during the incubation time and/or after the incubation time,
Separation of part of the phosphate-containing, heavy metal-poor liquid phase of the raw material dispersion and discharge of the remaining heavy metal-containing filter cake from the process,
Precipitation of phosphate from the phosphate-containing liquid phase,
Separation of the precipitated phosphate and return of the separated liquid phase to process step a) for the production of a raw material dispersion,
where the process stream B comprises the following process steps
Separation of part of the liquid phase of the raw material dispersion,
Production of a mixture of at least a part of the precipitated phosphate produced in process stream A and at least a part of the remaining raw material dispersion with reduced liquid phase from process step f) as well as granulation and/or extrusion of this produced mixture, whereby a drying or coating of the produced granulates and/or extrudates can take place and discharge of the produced heavy metal-depleted fertilizer granulate from the process streams A, B and C.
Recirculation of the liquid phase separated in process step f) for the production of a raw material dispersion analogous to process step a) and/or feeding into process step g), whereby at least partial separation of heavy metals from the liquid phase separated in process step f) and discharge of these heavy metals from the process can take place beforehand,
and repeat process steps a) to h).

In one embodiment, the phosphate-enriched, heavy metal-depleted fertilizer granules (10) according to the invention can be produced from at least one inorganic secondary phosphate (1) using a two-strand process, wherein the phosphate-enriched, heavy metal-depleted fertilizer granulate (10) has a higher phosphate concentration resulting (solely) from concentration of the phosphate component supplied from the at least one inorganic secondary phosphate (1) than in comparison with/against the mixture of the at least one inorganic secondary phosphate (1) supplied.

In other words, in embodiments of the fertilizer granules according to the invention, the fertilizer granules have a higher phosphate concentration due to enrichment/concentration of the added phosphate component(s) from the at least one inorganic secondary phosphate as compared to/against the added at least one inorganic secondary phosphate (1).

Consequently, the phosphate-enriched, heavy metal-depleted fertilizer granules (10) obtained according to the invention—in comparison to the at least one inorganic secondary phosphate (1) added and/or a mixture thereof-result in a higher phosphate concentration according to the invention due to the concentration/enrichment of the phosphate component added from the at least one inorganic secondary phosphate (1) and preferably a lower heavy metal concentration preferably due to heavy metal depletion according to the invention.

In embodiments, the phosphate-enriched, heavy metal-depleted fertilizer granules (10) have at least 30% higher phosphate concentration compared to the inorganic secondary phosphate(s) (1) supplied.

All percentages (%) in the context of the invention refer to weight percent (w/w % i.e. % w/w) unless otherwise stated.

Completely surprisingly, the combination of the precipitated phosphate according to the invention (produced via stream A) with the remaining raw material dispersion with reduced liquid phase from process step f) (obtained from stream B) leads to a phosphate-enriched phosphate-recyclate mixture, which has a significantly higher fertilizing effect. This higher fertilizing effect results on the one hand in improved plant growth compared to the individual products from the respective streams A and B.

This completely unexpected enhancing synergistic effect (“booster” effect) compared to the individual phosphate components from either stream A or stream B results from the combination of different phosphate phases obtained from the two different processes in streams A and B according to the invention. This synergistic effect of the combination of both processes in a single method according to the invention could not be derived from the prior art.

Phosphates in general are a mineral group that comprises numerous different phosphate phases such as Ca, Al, Fe and Mg phosphates and their largely complete mixed oxide combinations. The extensive substitutability of the cations results in mixed oxide variations such as whitlockite, which can be described by its molecular formula Ca₉ (Mg,Fe²⁺)[PO₃(OH)|(PO)₄₆. In addition, there is the variation of incorporated crystal and/or hydroxide in precipitation products depending on the type of precipitation process. Although all these variations are generally assigned to the phosphate group, some of them differ fundamentally in their crystal structure and the resulting bond forms. Due to their different crystal structures, the various phosphate phases each have very different chemical and physical properties. The chemical composition and dissolving properties are particularly important for the fertilizing effect. The phosphate must not only be generally soluble in the area of the root system, but also soluble over time so that the plant can absorb sufficient phosphate via the roots over the entire growth period. In addition, the soil flora should be adjusted or promoted in such a way that a growth-promoting environment is created around the root system. In addition to the physical solubility in the root area, the chemical composition of the added phosphate phase of the fertilizer plays an important role alongside the phosphate. Depending on the element, uptake by the roots can be promoted or prevented (e.g. through unsuitable complex formation, absorption) and the soil flora can be optimized for plant growth.

Through planting trials, the inventors have now surprisingly determined that the mixture of precipitated phosphate according to the invention, produced via stream A, with the remaining raw material dispersion with reduced liquid phase from process step f) in stream B, can be further processed according to the invention and thus leads to a phosphate mixture whose fertilizing effect was significantly higher than that of the respective individual components. For the phosphate mixture according to the invention, a greatly improved developmental bonitur (developmental quality) in the flowering stage, higher fresh masses in the growth period and a higher phosphate content in the plant sap analysis compared to the individual components from streams A and B were determined.

In stream A and stream B, the phosphate contained in the starting material (inorganic secondary phosphate) is converted in completely different ways. Although in both streams the phosphate is first dissolved by a reactant, in stream A the dissolved phosphate is specifically precipitated by adding a precipitating agent in step d). In stream B, on the other hand, no precipitant is preferably added, which is why the dissolved phosphate is not crystallized until the solubility limit is exceeded in the drying process, for example. This results in completely different phosphate phases as well as different morphological properties of the product, such as particle size or surface area.

It was completely surprising that the phosphate-enriched, heavy metal-depleted fertilizer granulate produced according to the invention, which is a specific mixture of the different phosphates produced from stream A and stream B, both ensures the phosphorus supply of plants and optimizes the development of microorganisms as well as bacteria and protozoa in such a way that the plants grow significantly better.

The soluble phosphate content is an important property in fertilizers and is usually determined by various extraction methods, for example using solvents such as water, ammonium citrate, citric acid, formic acid and mineral acids, whereby the neutral ammonium citrate-soluble portion of the phosphate can be of particular interest. The advantageous, synergistic effect of the fertilizer according to the invention was also surprising because these analytical methods of the soluble phosphate portion frequently used for characterization give comparable/similar results for the two individual different phosphates from stream A and stream B, so that a person skilled in the art would also expect a comparable fertilizing effect, and not a synergy, with a combination of both phosphates (with similar solubility).

It was by no means obvious to a person skilled in the art that a mixture of the different phosphates obtained from stream A and stream B would be suitable both for optimizing the animal live mass of the soil and for improving plant growth. This applies in particular to maize, wheat, onions, potatoes, millet, beans, apples, sugar beet, cucumbers and gherkins, grapes, tomatoes, barley and cabbage plants.

Accordingly, in a further aspect, the invention relates to a method for the production of a phosphate-enriched, heavy metal-depleted fertilizer granulate (10) producible from at least one inorganic secondary phosphate (1) by a two-stream process, wherein a raw material dispersion (3, 3′) is fed to process stream A and process stream B, in which this raw material dispersion is

either is produced in process step a) from at least one inorganic secondary phosphate (1) and at least one reactant (2) and this produced raw material dispersion (3) is fed divided to process stream A and B or in process step a), a′) the inorganic secondary phosphate (1) is first divided, two raw material dispersions (3, 3′) each comprising a partial amount of the at least one inorganic secondary phosphate (1) and at least one reactant (2, 2′) are produced separately from one another and these separately produced raw material dispersions (3, 3′) are fed to process streams A and B,

wherein the proportion of a liquid phase in the raw material dispersion (3, 3′) is greater than 30% and the incubation time between inorganic secondary phosphate (1) and reactant (2, 2′) is between 1 and 100 minutes, where the process stream A comprises the following process steps,
Addition of at least one heavy metal precipitation agent (4) during and/or after the incubation period,
Separation of part of the phosphate-containing, heavy metal-poor liquid phase (5) of the raw material dispersion and discharge of the remaining heavy metal-containing filter cake (6) from the process,
Precipitation of phosphate (7) from the phosphate-containing liquid phase (5),
Separation of the precipitated phosphate (7) and at least partial recycling of the separated liquid phase (8) to process step a) for the production of a raw material dispersion, where the process stream B comprises the following process steps
Separation of part of the liquid phase of the raw material dispersion (3),
Production of a mixture of at least a portion of the precipitated phosphate (7) produced in process stream A and at least a portion of the remaining raw material dispersion with reduced liquid phase (9) from process step f) and granulation and/or extrusion of this produced mixture, wherein drying or coating of the produced granules and/or extrudates can take place and discharge of the produced phosphate-enriched, heavy metal-depleted fertilizer granules (10) from the process,
At least partial recycling of the liquid phase 11, 11′) separated in process step f) for the production of a raw material dispersion analogous to process step a) and/or feeding into process step g), whereby at least partial separation of heavy metals (12) from the liquid phase separated in process step f) and discharge of these heavy metals (12) from the process can take place beforehand,
and repeat process steps a) to h).

In one embodiment of the method for producing a phosphate-enriched, heavy metal-depleted fertilizer granulate (10) from at least one inorganic secondary phosphate (1) by a two-strand process, the concentration of the phosphate component supplied from the at least one inorganic secondary phosphate (alone) results in a higher phosphate concentration in the phosphate-enriched, heavy metal-depleted fertilizer granules (10) compared to/as compared to the mixture of the at least one inorganic secondary phosphate supplied.

In other words, in embodiments of the method according to the invention, a higher phosphate concentration in the phosphate-enriched, low heavy metal fertilizer granules (10) results from the enrichment of the added phosphate component/phosphates from the at least one inorganic secondary phosphate compared to this added at least one inorganic secondary phosphate and preferably a lower heavy metal concentration preferably by a heavy metal depletion according to the invention.

In the context of the invention, all percentages (%) refer to weight percent (w/w % i.e. % w/w) unless otherwise stated.

The essence of the method according to the invention is that the phosphate-containing secondary phosphate(s) used is/are divided into two different process streams A and B, i.e. two process streams are used in parallel.

In process stream A, the phosphate is separated from the heavy metals from the at least one phosphate-containing secondary phosphate and precipitated. This results in a highly concentrated, precipitated phosphate, which is significantly more plant-available than the inorganic secondary phosphate used. A special feature of this process stream A is that the heavy metals that are not dissolved by the reactant (poorly soluble heavy metals) are separated in addition to the easily soluble heavy metals (dissolved by the reactant).

In process stream B, the (complete) portion of the at least one phosphate-containing secondary phosphate is converted into a fertilizer, whereby the phosphate is made available to plants and the heavy metals dissolved by the reactant can be separated at least in part and, according to the invention, the precipitated, largely heavy-metal-free phosphate produced in process stream A is fed to increase the phosphate content (phosphate-enriched) in the fertilizer produced. The precipitated phosphate produced in process stream A from the partial stream of phosphate-containing secondary phosphate used there increases the phosphate content of the fertilizer produced without the need to add a phosphate-containing nutrient component (phosphate-enriched) and leads to a reduced heavy metal content, particularly in the case of poorly soluble heavy metals.

“Phosphate-enriched” fertilizer within the meaning of the invention is defined by the fact that the phosphate concentration of the fertilizer produced in the method according to the invention, based solely on the total amount of phosphate supplied with the inorganic secondary phosphate, is higher than the phosphate concentration in the inorganic secondary phosphate used. Thus, for example, if an inorganic secondary phosphate used contains 7% P₂O₅ as phosphate, the method according to the invention results in a fertilizer with more than 7% P₂O₅ as phosphate, with this more than 7% P₂O₅ resulting solely from the inorganic secondary phosphate (e.g. phosphate-containing ash). If, in embodiments, additional phosphate-containing components (e.g. phosphoric acid or phosphate salts) are added in the process, this additional phosphate is not included in this more than 7% P₂O₅ but increases this proportion even further.

Since at least one inorganic secondary phosphate is used in the method according to the invention, several inorganic secondary phosphates can consequently also be used. The analogy between the inorganic secondary phosphate(s) used and the inorganic secondary phosphate(s) used in the specification and definition applies here. The method according to the invention thus comprises the use of at least one (or one or more) inorganic secondary phosphate(s). For the definition of “phosphate-enriched” fertilizer, the following therefore applies by way of example for the use of several inorganic secondary phosphates: The phosphate concentration of the fertilizer produced in the method according to the invention, based solely on the total amount of phosphate supplied with the inorganic secondary phosphates (in total), is higher according to the invention than the phosphate concentration in a mixture of the inorganic secondary phosphates used. If, for example, 50% inorganic secondary phosphate with 7% P₂O₅ and 50% inorganic secondary phosphate with 8% P₂O₅ are used, this results in a P₂O₅ concentration of 7.5% for the mixture of inorganic secondary phosphates used and of more than 7.5% P₂O₅ for the “phosphate-enriched” fertilizer according to the invention.

In accordance with the invention, the phosphate-containing secondary phosphates for process streams A and B are controlled in such a way that a desired phosphate content in the fertilizer product and the amount of separated heavy metals are specifically adjusted. The advantage of the two-stream method according to the invention (comprising stream A and stream B) is thus that an adjustable phosphate-enriched, heavy metal-depleted fertilizer granulate is produced from at least one inorganic secondary phosphate. Possible embodiments of the method according to the invention are shown in the following specification.

Surprisingly, the method according to the invention offers various advantages over known methods from the prior art, such as, for example:

In the phosphate conversion processes from the prior art described above, as known for example from DE 10 2010 034 042 B4 or WO 2019/149405 A1, a phosphate-containing combustion residue (inorganic secondary phosphate) is treated with the solvent (reactant) and both are transferred into the fertilizer product, resulting in a reduction (dilution) of the percentage of phosphate from the phosphate-containing combustion residue. On the other hand, the method according to the invention produces a phosphate-enriched fertilizer granulate with a higher phosphate concentration than the inorganic secondary phosphate used.

This increase in phosphate concentration is advantageous, for example, because potential users or processors often want high-phosphate phosphate fertilizers such as at least “superphosphate” (comprising approx. 18% P₂O₅), double superphosphate (comprising approx. 35% P₂O₅) or preferably triple superphosphate (comprising approx. 46% P₂O₅). The use of these superphosphates in agriculture or as a base component for the production of complex fertilizers is therefore more efficient and easier. These high-phosphate-rich fertilizers can be produced by the 2-strand method according to the invention, for example from sewage sludge ash, which typically has significantly lower P₂O₅ concentrations than, for example, 18%, 35% or even 46%. In process stream A of the method according to the invention, the inorganic secondary phosphate is converted into a highly concentrated precipitated phosphate (7). By transferring this highly concentrated, precipitated phosphate (7) into the fertilizer to be produced (process step g) in accordance with the invention, the phosphate content in the fertilizer produced is increased accordingly to the desired target value, for example to 18%, 35% or even 46%.

It is true that these prior art processes, such as DE 10 2010 034 042 B4 or WO 2019/149405 A1, offer the possibility of either using a phosphate-containing solvent (e.g. phosphoric acid) or adding phosphate-containing nutrient components (e.g. monoammonium phosphate (MAP)), which increases the phosphate content in the fertilizer accordingly and results in a high-phosphate fertilizer. However, these phosphate-containing solvents or nutrient components are more expensive than the fertilizer obtained according to the invention and are highly dependent on a volatile world market. In the method according to the invention, no additional phosphate-containing solvents need to be used or phosphate-containing nutrient components added in order to produce such high-phosphate fertilizers. This can be achieved solely by the method of concentrating the phosphate content from the inorganic secondary phosphate supplied according to the invention.

If phosphate-containing solvents or nutrient components from conventional production from rock phosphate are used, the fertilizers produced lose their status as pure phosphate recyclate, as the phosphate then no longer comes solely from recycling. This means that fertilizers produced in this way can no longer be used in the market segment for applications with high sustainability requirements, such as organic farming. Due to the possible concentration of the phosphate content in the method according to the invention, high-phosphate-rich fertilizers can be produced solely from the inorganic secondary phosphate used, which are therefore considered to be pure phosphate recyclate.

The P-conversion processes from the prior art, such as WO 2019/149405 A1, can separate some of the heavy metals. However, only the heavy metals that were previously dissolved by the solvent (reactant) can be separated. The undissolved heavy metals cannot be separated in these processes. In the method according to the invention, on the other hand, the heavy metals undissolved by the solvent (reactant) are also separated proportionally. Preferably, more than 30%, particularly preferably more than 50% of the heavy metals contained in the inorganic secondary phosphate and supplied to the process stream A and B with the inorganic secondary phosphate as a whole and not dissolved by the reactant are separated in the method according to the invention.

State-of-the-art leaching processes result in a very large amount of undissolved residues, as the leaching process is controlled in such a way that as much phosphate as possible and as few accompanying components as possible are dissolved. The accompanying components that are still dissolved are then separated in a complex, often multi-stage process. The separated undissolved residue and the separated with dissolved accompanying components could (basically only theoretically) be utilized elsewhere, but are typically waste for disposal. In the method according to the invention, on the other hand, an insoluble residue is only produced in process stream A. Unlike in the prior art, the accompanying components dissolved there are transferred to the fertilizer together with the precipitated phosphate and are therefore also not waste. In process stream B, all of the inorganic secondary phosphate supplied is transferred to the fertilizer and thus recycled. The method according to the invention thus produces significantly less undissolved residue (i.e. waste) than known leaching processes.

As a high product purity of the phosphate-rich products is to be achieved for most of the intended fields of application, valuable nutrients and trace elements (e.g. Mg, K, S), which are useful for plant nutrition and growth or for the soil condition as a basis for good yields, are lost through the desired complete separation of accompanying components in a classic leaching process. In a classic leaching process, these remain unused as waste in the undissolved residue. In the method according to the invention, however, these nutrients and trace elements are transferred into the fertilizer and are thus used instead of discarded. The transfer of these nutrients and trace elements according to the invention takes place on the one hand by the fact that in stream B no insoluble residue is separated and discharged, but the entire material can be transferred into the fertilizer. On the other hand, these co-dissolved nutrients and trace elements are not separated from the phosphate-rich solution (5) in stream A, but are transferred into the precipitated phosphate (7) during precipitation, and thus ultimately into the fertilizer.

The total amount of phosphorus (P) and heavy metals such as lead, cadmium and nickel are determined using inductively coupled plasma-atomic emission spectrometry (ICP-OES) in accordance with DIN EN ISO 11885:2009. For this purpose, the sample to be determined is first digested using aqua regia digestion in accordance with DIN EN 13346:2001-04. Various methods are known for determining the soluble phosphate content, in particular different extraction methods. To estimate the P availability, the fertilizers are tested in the laboratory with different solvents and labelled accordingly. The most important solvents used are water, ammonium citrate, citric acid, formic acid and mineral acids. Various methods for determining the phosphate solubility of fertilizers are also standardized in the EU regulation on fertilizers. Depending on the origin and nature of the P fertilizer to be tested, a different method may be used. In the context of the present invention, the following three extraction methods are used to characterize the solubility of the phosphate: Extraction of the phosphorus (P) soluble in water is carried out according to DIN EN15958:2011. Extraction of the phosphorus (P) soluble in neutral ammonium citrate is carried out according to DIN EN15957:2011. Extraction of the phosphorus (P) soluble in 2% citric acid is carried out according to DIN EN15920:2011. The phosphate content (P) is then determined using inductively coupled plasma-atomic emission spectrometry (ICP-OES) according to DIN EN ISO 11885:2009.

In particular, high proportions of water- and ammonium citrate-soluble phosphate ensure that a large proportion of the fertilizer phosphate is actually available to the plant in the short and medium term. The neutral ammonium citrate-soluble phosphorus content can be used as an indication of the medium-term plant availability of the fertilizer phosphorus, i.e. over the period of approximately one crop rotation. The immediately available P content of a fertilizer is specified by its solubility in water. The higher the water-soluble P content, the faster or easier the availability of the fertilizer phosphorus for the plant. Stronger solvents, such as citric acid or formic acid, also dissolve P components that are only available to plants in the long term or only under certain site conditions, such as low pH values. Planting and vegetation trials have shown that there is a particularly good correlation between neutral ammonium citrate-soluble phosphate content and plant growth. High water solubility makes phosphate available very quickly in large quantities, which the plant may not be able to absorb completely in the same time sequence during growth, so it remains unused and may be washed out. According to current scientific opinion, the use of P fertilizers which have a particularly high neutral ammonium citrate-soluble phosphate content should be preferred for reasons of resource conservation. In this respect, the present invention meets the requirement for high neutral ammonium citrate-soluble phosphate contents by using the proposed method to provide fertilizer granules with a particularly high neutral ammonium citrate-soluble P₂O₅ content of greater than 60%, preferably greater than 70%, particularly preferably greater than 80% of the total P₂O₅ content in the fertilizer granules.

For the purposes of the invention, fertilizers are substances or mixtures of substances which supplement or adjust the nutrient supply for the cultivated plants, in particular cultivated plants, in agriculture, forestry and horticulture, and they can be combined and/or functionalized with other materials if necessary. Fertilizers are understood here to be both single-nutrient fertilizers, such as phosphate fertilizers, and complex fertilizers. Fertilizer in granular form, i.e. fertilizer granules, is a pile typically in approximately spherical form and of sufficient inherent strength with an average granule size of 0.5-10 mm, preferably 1-7 mm, most preferably 2-5 mm.

For the purposes of the invention, inorganic secondary phosphates are substances which are formed during the processing, preparation or production of something (residue) and have a phosphorus content greater than 5% P₂O₅ and a TOC content (TOC=total organic carbon) of less than 3%. Examples of inorganic secondary phosphates are ashes and/or slags from the mono- or co-incineration of sewage sludge, ashes and/or slags from the incineration or co-incineration of animal excreta, meat and bone meal, animal remains and carcasses or ashes/slag from the incineration of liquid manure and fermentation residues as individual substances or mixtures thereof. The phosphorus compounds contained in the inorganic secondary phosphate, the intermediate products and fertilizers produced in the method according to the invention are referred to here as phosphate and the phosphorus or phosphate concentration is uniformly given as P₂O₅, even if this does not or does not fully correspond to the binding type of the phosphorus in individual cases.

Organic sludges, such as sewage sludges, are expressly not inorganic secondary phosphates according to the invention, as their TOC content is well above the defined limit of 3%. However, the chemical-physical constitution of sewage sludge also differs fundamentally from the inorganic secondary phosphates according to the invention, for example in the type, concentration and plant availability of the phosphate it contains. Sewage sludge is directly suitable as a fertilizer and has been used for this purpose for decades, as the phosphates are already present in it in a sufficiently plant-available form. A sewage sludge ash according to the invention (as one possibility for an inorganic secondary phosphate) is produced by the thermal incineration of sewage sludge. However, the phosphates in the sewage sludge are converted into poorly soluble Ca—(Mg)-phosphates by the incineration process. This means that although phosphates are present in both the sewage sludge and the sewage sludge ash, the binding form of the phosphates is fundamentally different. This results in fundamentally different requirements for the reaction process in terms of improved solubility and plant availability. Sewage sludge has been used as a fertilizer for decades, as the phosphates are sufficiently available to plants. In contrast, sewage sludge ashes are not suitable as fertilizers without prior digestion due to the different phosphate form, i.e. the poorly soluble phosphates present here, as the plants cannot absorb the poorly soluble phosphates to a sufficient extent.

In the context of the present invention, a reactant is to be understood as a substance or a mixture which, on the one hand, dissolves and/or reacts with at least some of the phosphate supplied by the inorganic secondary phosphate and, on the other hand, dissolves at least some of the heavy metals from the inorganic secondary phosphate. The reactant is preferably adapted to dissolve and/or react with at least part of the phosphate contained in the inorganic secondary phosphate or to convert the phosphate by reaction in such a way that a phosphate which is more soluble in neutral ammonium citrate is formed. In the subsequent process, for example by precipitation, recrystallization or during drying, the phosphate preferably dissolved by the reactant advantageously forms a phosphate that is more soluble in neutral ammonium citrate than the phosphate contained in the inorganic secondary phosphate. The phosphate solubility in the phosphate-enriched, heavy metal-depleted fertilizer granules (10) produced is preferably determined by the type of phosphate binding and the solution environment (e.g. chemical composition and/or pH value). This can be influenced, for example, by the type and concentration of the reactant. In addition to other parameters such as the reaction process and reaction time, the type and concentration of the reactant can also influence the type and proportion of dissolved heavy metals. Reactants are, for example, organic or inorganic acids or acid mixtures or alkalis or mixtures of different alkalis, each in undiluted or diluted form.

In the context of the present invention, the liquid phase is defined as the sum of the liquid substances in a coherent system. Thus, the raw material dispersion comprises a solid phase and a liquid phase. In the context of the present invention, the solid phase is the sum of the undissolved substances. The liquid phase in a system, for example in a raw material dispersion, can thereby be formed from different liquid components. For example, liquid components can be supplied at least proportionally in the form of moisture, proportionally in a suspension or as a liquid via various substances or, for example, as water, or can be contained at least proportionally in the reactant, for example liquid acids, in particular also diluted acids. For the purposes of the invention, the term “moisture” corresponds to the physically bound water (water content) which adheres to the substance or mixture of substances. The term “moisture” is also used synonymously with the term “moisture content”.

In the context of the present invention, the moisture or moisture content is determined gravimetrically in accordance with DIN 52183. In the gravimetric moisture determination, also known as the Darr method, the sample is first weighed and then dried at 105° C. in a drying oven until the weight is constant. During this process, the free water contained in the sample escapes. The difference in weight is determined, which in the context of the present invention corresponds to the moisture or moisture content. Since the liquid phase can also contain dissolved components that remain as solids during drying, the percentage of the liquid phase is usually significantly higher than the moisture content in some cases. The percentage of liquid phase corresponds to the mass proportion of liquid components (including dissolved components) in a system.

In process step a), a raw material dispersion is provided for process stream A and process stream B, whereby the proportion of liquid phase in the raw material dispersion is greater than 30%.

In a preferred embodiment, a raw material dispersion is produced for this purpose from at least one inorganic secondary phosphate and at least one reactant and this produced raw material dispersion is fed to process stream A and B in divided form. The advantage of this embodiment is, for example, that the production of only one raw material dispersion for process stream A and B together is easier in terms of handling, less complex in terms of process control and only one suitable reaction container is required for the production of the raw material dispersion.

In another preferred embodiment, the inorganic secondary phosphate is first divided into two separate sub-streams for subsequent further processing in process streams A and B.

One embodiment comprises the variant that at least one inorganic secondary phosphate is first divided into two separate partial streams for subsequent further processing in process stream A and B. One embodiment further comprises the variant that, if several inorganic secondary phosphates are used, these are mixed beforehand and the inorganic secondary phosphate mixed in this way is then divided into two separate partial streams for subsequent further processing in process streams A and B. In embodiments, the separate partial streams for process stream A and B may also comprise different inorganic secondary phosphates or different amounts of different inorganic secondary phosphates. From the divided partial streams, a raw material dispersion is then produced separately from the respective partial stream of the at least one inorganic secondary phosphate or a mixture of inorganic secondary phosphates and at least one reactant and fed to process stream A and B, respectively. The advantage of these embodiments is that the two separate raw material dispersions produced in this way can be conditioned differently, adapted to the respective process stream. For example, different reactants or different proportions of liquid phase can be used or different reaction parameters such as pH value or incubation time can be selected in order to specifically adjust the dissolution and conversion reaction between inorganic secondary phosphate and reactant, also with regard to the requirements for different further processing in process stream A or B. For example, in a preferred embodiment, the proportion of dissolved phosphate from the inorganic secondary phosphate in the raw material dispersion for process stream A can be set to greater than 90%, resulting in a particularly economical recovery of the phosphate as a phosphate-containing filter cake from this partial stream. In the raw material dispersion for process stream B, on the other hand, the phosphate can initially be dissolved, for example, but then at least partially precipitated, which results in easier separation in the subsequent process step.

The raw material dispersion used in the context of the proposed method has a significantly higher proportion of liquid phase compared to conventional processes known from the prior art, for example from DE 10 2010 034 042 B4. It is known in the prior art that the phosphate ashes are mixed directly with mineral acid in a moist state and granulated at the same time. The production of a raw material dispersion envisaged in the context of the proposed invention thus has considerable technical advantages. For example, the reactions that often occur spontaneously when mixing the phosphate-containing secondary raw materials with the mineral acid, some of which are very exothermic, can be controlled and regulated. The higher proportion of liquid phase according to the invention advantageously acts as a reaction buffer. A raw material dispersion with a significantly higher proportion of liquid phase is also much less sticky. Stable process control is thus significantly facilitated and adhesion and clogging of system parts can be effectively reduced. For this reason, the raw material dispersion(s) produced contain(s) a liquid phase content of preferably greater than 50%, particularly preferably greater than 70%.

In a preferred embodiment of the invention, the raw material dispersion(s) preferably contain(s) an undissolved solid phase of less than 40% after the incubation time according to the invention. In this range, a particularly good and simple homogenization of the produced raw material dispersion is possible. In a particularly preferred embodiment of the invention, one or both raw material dispersion(s) contains an undissolved solid phase of less than 30% after the incubation time according to the invention. At such ratios, the dissolution rate is relatively high, whereby the necessary reaction time can advantageously be shortened. In another, also preferred embodiment of the invention, the raw material dispersion fed to the process stream B after the incubation time according to the invention contains a solid phase content of less than 15%. With this low undissolved content and, respectively, high liquid phase content, relatively low concentrations of the dissolved heavy metals are found in the liquid phase, because the dissolved content of heavy metals is diluted by the high liquid phase content. The partial separation of the liquid phase in process step f) then results in a lower heavy metal content in the liquid phase that remains with the solid and is not separated. This results in a desired higher heavy metal separation in step f) with the same separation intensity.

To adjust the preferred proportion of liquid phase, one or more liquid components can be added to the raw material dispersion(s). In a preferred embodiment of the invention, the liquid phase from process step h) is at least partially recycled to process step a). This liquid phase from process step h) may still contain a proportion of the dissolved nutrient components, for example phosphate. Alternatively or additionally, water and/or liquid nutrient-containing solutions can also be added. Nutrient-containing solutions preferably contain nutrients and/or trace substances that are contained in the proposed fertilizer granules.

The phosphate contained in the inorganic secondary phosphate advantageously serves as a nutrient component in the fertilizer produced. High phosphate contents, especially in the inorganic secondary phosphate, are desirable here. Preference is therefore given to inorganic secondary phosphates with greater than 5% P₂O₅, particularly preferably with greater than 7% P₂O₅ and very particularly preferably with greater than 10% P₂O₅. In addition, the inorganic secondary phosphate may contain further components. It is advantageous if further nutrient components are contained, for example N, K, Mg or other trace nutrients.

The phosphate content present in the inorganic secondary phosphate typically has a relatively low solubility. Accordingly, such substances, such as sewage sludge ashes, are only suitable as fertilizers to a limited extent. Typically, these inorganic secondary phosphates have a water solubility of less than 20% and a neutral ammonium citrate solubility of less than 50%, preferably in relation to the total phosphate content in the inorganic secondary phosphate. For a useful application as a fertilizer, it is preferred in the sense of the invention that this insufficiently soluble phosphate is converted into a more soluble and thus more plant-available phosphate. According to the invention, the conversion takes place by at least partial reaction of the inorganic secondary phosphate with at least one reactant. The reactant is preferably set up to dissolve at least part of the phosphate contained in the inorganic secondary phosphate and/or to react with it or to convert the phosphate by reaction in such a way that a phosphate which is more readily soluble in neutral ammonium citrate is formed. In the subsequent process, for example by precipitation, recrystallization or during drying, the phosphate preferably dissolved by the reactant advantageously forms a phosphate that is more soluble in neutral ammonium citrate than in the inorganic secondary phosphate. For the purposes of the invention, the term “better neutral ammonium citrate soluble” preferably means that the neutral ammonium citrate solubility of the phosphate in the inorganic secondary phosphate is higher after reacting with the reactant. Preferred is an increase in the neutral ammonium citrate solubility of greater than 20%, particularly preferred is an increase of greater than 50%. A corresponding calculation example may be as follows: the neutral ammonium citrate solubility of the phosphate content from the untreated secondary phosphate of 50% is increased by 20% to 60% by reacting with the reactant. The reactant is selected in particular in such a way that it preferably fulfills the above requirements when added. When acids are used, the proposed method differs from the prior art in particular in that the phosphate reacts at least partially and the solubility is increased.

It is preferred in the sense of the invention that the solubility of the phosphate from the inorganic secondary phosphate is increased by the reaction between the inorganic secondary phosphate and the reactant. The P-solubility is preferably determined by the type of P-bond and the solution environment. The type of reaction control in process step a) can influence the binding of the P, i.e. the phosphate phases that form. This can be done, for example, by the type and concentration of the reactant, the reaction time and/or the process temperature. Preferably, the phosphate content from the inorganic secondary phosphate subsequently in the fertilizer granulate produced has a neutral ammonium citrate solubility of greater than 60%, preferably greater than 70%, particularly preferably greater than 80%. Due to the preferred reaction or conversion of the phosphate and the preferred resulting neutral ammonium citrate solubility from the inorganic secondary phosphate, a better phosphate plant availability and thus an improved fertilizing effect are advantageously achieved. In a preferred embodiment of the invention, the reaction control is preferably controlled such that the phosphate fraction from the inorganic secondary phosphate subsequently has a neutral ammonium citrate solubility of greater than 60% and a water solubility of less than 40% in the fertilizer granules produced. By adjusting the solubilities in this form, the phosphate is actually sufficiently available to the plants in the field for about one growing season, but is not washed out during this time. Leaching can typically occur if the water solubility is very good, i.e. significantly higher than intended here. In a particularly preferred embodiment of the invention, a neutral ammonium citrate solubility of greater than 80% and a water solubility of less than 30% is set for the phosphate content from the inorganic secondary phosphate in the fertilizer granules produced. Surprisingly, it has been shown that this provides winter rye in particular with a particularly favorable P supply over a growth period. In another particularly preferred embodiment of the invention, a neutral ammonium citrate solubility of greater than 90% and a water solubility of less than 15% is set for the phosphate content from the inorganic secondary phosphate in the fertilizer granules produced. This ratio is particularly favorable for wheat plants.

The type and concentration of the reactant, the reaction process and reaction time can also influence the type and proportion of dissolved heavy metals. For example, a higher acid strength preferably results in a higher proportion of dissolved heavy metals. A higher proportion of dissolved heavy metals is preferred in this process step, as this means that more heavy metals can be separated in process step f) with the partial separation of the liquid phase and fed to the at least partial separation of the heavy metals in process step h).

In a preferred embodiment of the invention, at least one reactant is used which comprises at least one of the elements nitrogen (N), sulfur(S), potassium (K) and/or phosphorus (P), for example phosphorous acid (H₃ PO₃), phosphoric acid (H₃ PO₄), nitric acid (HNO₃), sulfuric acid (H₂ SO₄), sulfurous acid (H₂ SO₃) and/or potassium hydroxide (KOH). By using such reactants, additional nutrient components such as nitrogen, sulfur, potassium and/or phosphorus are introduced into the granules. The nutrient binding form of the nutrients contained in the reactant, e.g. nitrogen and/or sulfur, can preferably be converted into a form suitable for the fertilizer by means of a suitable reaction sequence.

The components of the raw material dispersion can be combined in any order. What is necessary in the sense of the invention is that the reactant in process step a) reacts in a sufficient manner with at least part of the phosphate supplied by the inorganic secondary phosphate. In the context of the invention, the term “react sufficiently” means that the desired improvement in the neutral ammonium citrate solubility of the phosphate is achieved. Accordingly, in process step a), an incubation time is provided in the sense of allowing the reactant to act on the inorganic secondary phosphate. The incubation according to process step a) takes place over a period in the range from 1 to 100 minutes, preferably in the range from 5 to 60 minutes and particularly preferably in the range from 10 to 30 minutes. The order in which the components are combined, the time sequence and the incubation time can, for example, influence the reaction that takes place and thus also the proportion of dissolved heavy metals and the neutral ammonium citrate solubility of the phosphate in the fertilizer granulate produced.

The intended separation of the reaction for at least partial phosphate conversion from the inorganic secondary phosphate from the subsequent process steps preferably solves the technical problem that the exothermic reaction, which in some cases takes place spontaneously and violently, greatly hinders further process control. The separation of the reaction from the subsequent process steps according to the invention is preferably to be understood in the technical sense in such a way that by far the largest proportion of the reaction takes place in process step a). However, it may also be preferable for the reaction to continue in the subsequent process steps, but then at a significantly reduced intensity. By adhering to the incubation time according to the invention, the remaining intensity of the possible continuation of the reaction is no longer a hindrance to the process control. In a preferred embodiment of the invention, process step a) is preferably controlled such that more than 80% of the neutral ammonium citrate solubility increase of the inorganic secondary phosphate achieved over the entire process is achieved in process step a). This means that if the reaction were stopped after process step a) by rapid drying, the phosphate from the inorganic secondary phosphate treated with the reactant of this reaction product stopped in this way already shows at least 80% of the neutral ammonium citrate solubility of a reaction product which is not stopped but still undergoes process steps b) and c).

Further components can be added to the raw material dispersion in process step a). Further components here are generally substances that can improve the process control and/or the properties of the fertilizer granules, for example nutrient-containing components, dispersing and defoaming agents, structural substances, agents for pH adjustment, urease inhibitors, ammonium stabilizers, humic acid, organic acids and/or water.

The pH value of the raw material dispersion produced can be adjusted during or after the incubation time if required. In a preferred embodiment, the pH is adjusted between 1-2, as the dissolved phosphate still remains largely dissolved in this range. In another preferred embodiment, the pH of the raw material dispersion for process stream B is adjusted above a pH of 2, whereby the dissolved phosphate is at least precipitated. In a particularly preferred embodiment, the pH of the raw material dispersion for process stream B is adjusted to a value above 3, as this causes the dissolved phosphate to precipitate particularly well. In a very special embodiment, the pH value is adjusted in such a way that more than 90% of the dissolved phosphate precipitates. This simplifies the partial separation of the liquid phase in process step f) due to the lower dissolved content.

Thus, in embodiments of the invention, the phosphate-enriched, heavy metal-depleted fertilizer granules (10) according to the invention and/or the method according to the invention are characterized in that that in process step b) the addition of the at least one heavy metal precipitation agent (4) and the heavy metal precipitation are carried out at a pH value of less than 2 and the separation of a part of the phosphate-containing, heavy metal-poor liquid phase (5) of the raw material dispersion and discharge of the remaining heavy metal-containing filter cake (6) from the process also take place at a pH value of less than 2.

The amount of raw material dispersion and thus inorganic secondary phosphate (partial stream) provided for each process stream A and process stream B is adjusted, for example, according to the product quality requirements of the fertilizer produced and/or for economic considerations. In contrast to prior art processes, the flexibly adjustable quantity of the partial streams according to the invention allows the process to be controlled in such a way that it is particularly economical even if the chemical constitution of the inorganic secondary phosphates varies or fluctuates, while still complying with the quality requirements, for example with regard to the limit values for heavy metals.

According to the invention, the heavy metals not dissolved during the reaction between inorganic secondary phosphate and reactant can also be largely separated in process stream A, while in process stream B (only) the heavy metals present in solution can be separated in process step h). Thus, by adjusting the amount of inorganic secondary phosphate added in process stream A and process stream B, not only an overall removal rate of heavy metals but also a targeted removal rate of particularly problematic heavy metals that exceed the limit values, for example, can be set. For example, the partial stream quantity of inorganic secondary phosphate fed to process stream A can be used to influence the removal rate of heavy metals that are not dissolved by the reactant.

In process stream A, an insoluble residue is produced (as is typical for leaching processes), which usually has to be disposed of as waste. In process stream B, on the other hand, no such process residue is produced. The way in which the amount of inorganic secondary phosphate is divided between process stream A and B influences the amount of this residue. In contrast to known leaching processes from the prior art, however, a partial stream of the inorganic secondary phosphate is always fed to process stream B in accordance with the invention. As a result, the amount of process residue from the overall process is smaller, which is not only more cost-effective. The accompanying components from the inorganic secondary phosphate transferred to the fertilizer in process stream B also contain additional nutrients and trace substances required by the plant. This saves the addition of such components from conventional production and makes the process not only more economical, but also more sustainable.

In process stream A, the inorganic secondary phosphate is converted into a highly concentrated phosphate. By transferring this highly concentrated phosphate into the fertilizer to be produced (process step g) in accordance with the invention, the phosphate content in the fertilizer produced is increased. Depending on the distribution of the inorganic secondary phosphate to process streams A and B, an adjustable, in any case higher P concentration than in the inorganic secondary phosphate can be achieved in the fertilizer without the addition of an additional phosphate as a nutrient component than would result from process stream B alone. This is economically advantageous, as phosphate nutrient components are expensive and increasingly difficult to obtain.

In the method according to the invention, this resulting phosphate concentration in the fertilizer produced can surprisingly be achieved by adjusting the partial stream quantities for process streams A and B. According to the invention, a phosphate-enriched fertilizer is produced, wherein the phosphate concentration of the fertilizer produced, based solely on the phosphates supplied with the inorganic secondary phosphate, is higher than the phosphate concentration in the supplied inorganic secondary phosphate itself. In a particularly preferred embodiment, the at least one inorganic secondary phosphate is divided between the partial stream quantities in such a way that the phosphate concentration in the fertilizer granules produced is at least 30% higher, based solely on the phosphate supplied with the inorganic secondary phosphate or the mixture of several inorganic secondary phosphates supplied, than in the inorganic secondary phosphate supplied. This results in a particularly phosphate-rich fertilizer granulate, which is suitable for further packaging with other nutrients, for example. If, for example, the inorganic secondary phosphate used in this embodiment contains 7% P₂O₅ as phosphate, this inorganic secondary phosphate is divided between process stream A and B in such a way that a fertilizer granulate with more than 9.1% P₂O₅ as phosphate (based on phosphate only from the inorganic secondary phosphate) results. If several inorganic secondary phosphates are used at the same time, this results in an average phosphate concentration for the inorganic secondary phosphate and the calculation form analogous to this.

Thus, embodiments of the phosphate-enriched, heavy metal-depleted fertilizer granules (10) obtained according to the invention and/or the method according to the invention are characterized in that the phosphate-enriched, heavy metal-depleted fertilizer granules (10) have a phosphate concentration at least 30% higher than the inorganic secondary phosphate(s) supplied. In other words, in embodiments, the fertilizer granulate (10) obtained according to the invention and/or the method according to the invention is characterized in that the phosphate-enriched, heavy metal-depleted fertilizer granulate (10) has a phosphate concentration which is at least 30% higher than that supplied by and/or contained in the inorganic secondary phosphate(s) (1) (starting materials) used.

According to the invention, heavy metal depletion takes place in the process. Preferably, the depletion of at least 20% of the total amount of heavy metals (sum of all heavy metals) supplied by the inorganic secondary phosphate(s) can be achieved, particularly preferably the depletion of more than 30% of the total amount of heavy metals supplied by the inorganic secondary phosphate, whereby fewer heavy metals are discharged into the environment by the fertilizer produced during fertilization.

Therefore, embodiments of the phosphate-enriched, heavy metal-depleted fertilizer granules (10) according to the invention and/or the method according to the invention are characterized in that the phosphate-enriched, heavy metal-depleted fertilizer granules (10) have a total heavy metal concentration that is at least 20% lower than the inorganic secondary phosphate(s) supplied. In other words, in embodiments of the phosphate-enriched, heavy metal-depleted fertilizer granules (10) according to the invention and/or the method according to the invention, the latter is characterized in that the phosphate-enriched, heavy metal-depleted fertilizer granules (10) have an amount of heavy metals which is at least 20% lower in total than is supplied by the at least one inorganic secondary phosphate used.

A problem with prior art methods such as WO 2019/149405 A1 is that only the heavy metals that have previously been dissolved by the reactant can be separated.

In the method according to the invention, these heavy metals which are not dissolved by the reactant can surprisingly also be separated in process stream A. In a preferred embodiment, the at least one inorganic secondary phosphate is divided between the partial stream quantities in such a way that the heavy metals supplied by the inorganic secondary phosphate and not dissolved by the reactant are reduced by at least 30% in the fertilizer granules produced. The depletion of these heavy metals essentially takes place in the process stream A according to the invention. If, for example, 100 mg/kg of a type of heavy metal (e.g. Pb) added to the process by the inorganic secondary phosphate is not dissolved by the reactant, at least 30 mg/kg of it is removed from the process and thus not transferred to the fertilizer granulate. For many inorganic secondary phosphates, the separation of such an amount of heavy metals is sufficient to fall below the limit values for a legally compliant fertilizer. In another preferred embodiment, at least 50% of these undissolved heavy metals are removed from the process. This embodiment is necessary, for example, if the inorganic secondary phosphate has a particularly high heavy metal concentration of this type of heavy metal and this embodiment is particularly sustainable, as less heavy metals are thereby introduced by agriculture through the fertilizer produced.

In process step b), a heavy metal precipitation agent is added to the raw material dispersion produced and fed to process step b) in process stream A during the incubation time and/or after the incubation time.

Therefore, embodiments of the phosphate-enriched, heavy metal-depleted fertilizer granules (10) according to the invention and/or the method according to the invention are characterized in that in process step b) at least one heavy metal precipitation agent is added during the incubation time.

In embodiments, in process step b) more than 80% of the total heavy metals present in solution are precipitated from the raw material dispersion (3, 3′) by the added at least one heavy metal precipitation agent (4), wherein after the heavy metal precipitation at least 80% of the P₂O₅ previously present in solution is still present in solution in the raw material dispersion (3, 3′).

According to the invention, heavy metal precipitation agents are to be understood as substances which can precipitate or crystallize heavy metals present in solution in the raw material dispersion, i.e. which can transfer them from the dissolved phase to the solid phase. Such heavy metal precipitation agents can, for example, be substances that raise the pH value of the raw material dispersion, whereby the dissolved heavy metals precipitate at least partially. Examples of such substances are alkalis such as NaOH, KOH or basic substances such as CaO, MgO, Mg(OH)2 or Ca(OH)₂. However, heavy metal precipitation agents can also be substances that react with the dissolved heavy metal and precipitate at least proportionally as a compound. Examples of this type of substance are sulfides such as H₂S, CH₄N₂S, Na₂S, which react with the heavy metals to form heavy metal sulfides. A heavy metal precipitation agent in the sense of the invention can also be a so-called sacrificial metal. In the sense of the invention, a sacrificial metal is preferably a less noble metal than the heavy metals to be separated, for example selected from the group of aluminum, iron and zinc or mixtures thereof. If the sacrificial metal comes into contact with the dissolved heavy metals, a reduction of the more noble metals present in solution advantageously takes place on the surface of the less noble sacrificial metal, which is oxidized in the process and thus at least partially passes into the solid state. The reductive conditions can be triggered or intensified by the addition of a suitable reducing agent.

Therefore, embodiments of the phosphate-enriched, heavy metal-depleted fertilizer granules (10) according to the invention and/or the method according to the invention are characterized in that at least one heavy metal precipitation agent (4) added, preferably in process step b), is a sulfide.

According to the invention, the addition of the heavy metal precipitation agent transfers at least some of the heavy metals present in dissolved form in the raw material dispersion supplied in process step b) into the solid phase. This enables the separation of these heavy metals, which are then present as undissolved, by means of a simple solid-liquid separation in process step c).

Preferably more than 50%, particularly preferably more than 70% of the heavy metals dissolved in the raw material dispersion are transferred into the solid phase by the heavy metal precipitation agent. Since the necessary reaction between the inorganic secondary phosphate and the reactant dissolves relevant proportions of heavy metals, typically Cd or As in particular in the case of sewage sludge ashes, for example, such separation rates are necessary in order to comply with the required limit values in the fertilizer produced. In a particularly preferred embodiment, the heavy metal precipitation agent transfers more than 80% of the heavy metals dissolved in the raw material dispersion supplied into the solid phase, resulting in a fertilizer granulate with a particularly low heavy metal concentration.

To increase the effectiveness of the heavy metal precipitation agent, the raw material dispersion can be conditioned in process step a) and/or process step b). Conditioning means that the properties of the raw material dispersion or the reaction environment are improved with regard to an increased precipitating effect of the heavy metals. Such conditioning can, for example, be the adjustment of the pH value, the temperature, the redox potential or the concentration of the dissolved substances.

In a preferred embodiment, more than 80% P₂O₅ of the inorganic secondary phosphate added in process step b) is dissolved and the heavy metal precipitation agent is added and the heavy metals are transferred to the solid phase at pH values of less than 2. In this range, the dissolved phosphate is largely dissolved even without prior complexation. One or more sulfide(s) such as H₂S, CH₄N₂S, Na₂S are preferred as heavy metal precipitation agents. The dissolved heavy metals are at least partially precipitated as heavy metal sulfides by the added sulfides. Surprisingly, it was found that in a particularly preferred embodiment, more than 80% of the total dissolved heavy metals can be precipitated by sulfide(s) as a heavy metal precipitation agent even in this low pH value range below 2, whereby the phosphate, which is also dissolved in the raw material dispersion, is still present in a dissolved state with more than 80% (based on the previously dissolved proportion). If, for example, a total of 100 mg of heavy metals (e.g. as the sum of Cd, As, Cu) and 5 g of P₂O₅ are dissolved in the raw material dispersion, less than 20 mg of the total heavy metal and more than 4 g of P₂O₅ are dissolved after the addition of sulfide(s) as a heavy metal precipitation agent and the precipitation reaction.

Therefore, embodiments of the phosphate-enriched, heavy metal-depleted fertilizer granules (10) according to the invention and/or the method according to the invention are characterized in that in process step b) more than 80% of the total heavy metals present in dissolved form are precipitated from the raw material dispersion by the added at least one heavy metal precipitation agent (4), at least 80% of the previously dissolved P₂O₅ still being present in dissolved form in the raw material dispersion after the heavy metal precipitation.

In a preferred embodiment, the addition of the sulfide(s) takes place in the pH value range below 1. Surprisingly, it was found that the desired precipitation of the heavy metals by sulfides in the reaction environment of the raw material dispersion also occurs sufficiently quantitatively at these very low pH values. The advantage of this is that the sulfide can be added during the incubation time or while the reaction between the inorganic secondary phosphate and the reactant is still ongoing. As a result, the reaction between the inorganic secondary phosphate and the reactant and between the heavy metal precipitation agent and the dissolved heavy metals take place simultaneously, at least temporarily, which shortens the overall process time or enables a longer reaction time for the same overall process time. In another preferred embodiment, the addition of the sulfide(s) takes place in the pH range between 1 and 2. The advantage of this embodiment is that precipitation by sulfide in this pH range is more efficient than in the pH range below 1, i.e. a higher amount of heavy metals is precipitated. At the same time, the dissolved phosphate remains largely in dissolved form.

In process step c) of the proposed method, a portion of the phosphate-containing, heavy metal-poor liquid phase is separated from the raw material dispersion produced in process step a) and fed to process stream A, and the resulting heavy metal-containing filter cake is discharged from the process.

The heavy metals contained in the heavy metal-containing filter cake are preferably also removed from the process. On the one hand, this includes the proportion of heavy metals that preferably are not dissolved in process step a) and/or b), in particular by the reactant used. These heavy metals cannot be separated via the process control in stream B.

By controlling the amount of inorganic secondary phosphate added for streams A and B and the process design in stream A (such as type of reactant, incubation time, reaction conditions), the desired amount of these heavy metals, which are not dissolved by the reactant, can thus be discharged in process step c) of stream A. This is typically at least partially Pb, Zn, Ni. Typically, this is at least proportionally Pb, Zn, Ni, for example. On the other hand, this includes the proportion of heavy metals that precipitate out again in this process step until the heavy metal-containing filter cake is separated, for example by the precipitant in process step b).

It is preferable to separate so much phosphate-containing, low heavy metal liquid phase in this process step that the moisture in the heavy metal-containing filter cake is less than 50%. By separation of such a proportion of liquid phase in which the phosphate is dissolved, a considerable proportion of phosphate can be obtained for the further process and thus an economically interesting yield of phosphate. In a particularly preferred embodiment, so much phosphate-containing, heavy metal-poor liquid phase is separated that the moisture in the heavy metal-containing filter cake is less than 40%. This advantageously means that less water has to be removed from the heavy metal-containing filter cake by drying before landfilling, which is more cost-effective.

The partial separation of the liquid phase within the meaning of the present invention can be carried out continuously and/or discontinuously in one or more steps, for example by filtration or centrifugation. The filtration can be carried out discontinuously, for example by means of autopress, pressure funnel, agitated pressure funnel, suction funnel, disk filters, (pressure) leaf filters, bag filters, candle filters, bag filters, sheet filters, filter presses, such as e.g. frame filter presses, chamber filter presses, membrane filter presses. frame filter presses, chamber filter presses, membrane filter presses; plate filters and/or bulk filters or continuously, for example by means of crossflow filtration, shear gap filters, tubular rotor filters, belt filters, rotary pressure filters, drum filters, rotary vacuum filters, disk pressure filters and/or sliding belt presses, without being limited to these. Centrifuging can be carried out continuously by, for example, sieve centrifuges, sieve screw centrifuges, impact ring centrifuges, sliding centrifuges, pusher centrifuges, oscillating centrifuges, tumbling centrifuges and/or solid bowl centrifuges or discontinuously by, for example, suspended pendulum centrifuges, horizontal peeler centrifuges, inverting filter centrifuges, pusher bag centrifuges and/or vertical centrifuges. For the purposes of the invention, it is preferred that the solid-liquid separation is carried out by means of filter presses or vacuum belt filters.

In the case of partial separation of the liquid phase, it is preferably not absolutely necessary that all solid components are completely separated from the separated liquid phase. In particular, very fine solid particles, which are preferably referred to as suspended particles in the sense of the invention, can preferably remain in the separated phase. On the one hand, this simplifies the separation process, for example during filtration or centrifugation, since the complete separation of fine particles in particular is very time-consuming in a solid-liquid separation with a high solid loading. It is therefore preferred that a solids content of less than 10%, particularly preferably less than 5% and very particularly preferably less than 2% is set in the separated liquid phase.

In process step d) of the proposed method, at least a proportion of the dissolved phosphate is precipitated in the liquid phase separated in process step c), i.e. at least a proportion of the dissolved phosphate is transferred to the solid phase.

The precipitation of the dissolved phosphate can be carried out using the method known to the skilled person. It may be advantageous for the separated liquid phase to be conditioned before or during this process, for example by setting a desired process temperature or by adding substances such as defoaming agents or dispersants to the liquid phase to change its physico-chemical properties.

In a preferred embodiment, the precipitation of the dissolved phosphate in the liquid phase separated in process step c) is carried out by increasing the pH value. The separated liquid phase preferably has a pH value of less than 2. If the pH value is increased, as provided for in this preferred embodiment, the dissolved phosphate precipitates at least partially. The pH value range of this precipitation of phosphate depends, for example, on which type of phosphate (e.g. aluminum phosphate, iron phosphate, calcium phosphate) can be formed in the process. In this preferred embodiment, a substance is added to the separated liquid phase which preferably raises the pH value of this separated liquid phase above 2. In a particularly preferred embodiment, the pH value is set in a range between 2-4. In this pH value range, a sufficiently quantitative precipitation, preferably more than 80% of the dissolved phosphate, typically takes place. In a particularly preferred embodiment, the precipitation of the phosphate takes place in the pH range from 2 to 3. The advantage of this embodiment is that after separation of the precipitated phosphate (process step e)), a (low-phosphate) liquid phase results which has a comparatively low pH value. For a possible return of this separated liquid phase to process step a) for the production of a raw material dispersion, it is advantageous if the pH value is already low, as this means, for example, that less acid has to be used.

All substances or mixtures of substances that influence the pH value in the desired way can be used to raise or adjust the pH value. In a preferred embodiment, at least one NaOH or sodium hydroxide solution is added to the separated liquid phase to raise the pH value. NaOH or caustic soda is inexpensive and is available in sufficiently large quantities. In another preferred embodiment, at least one calcium compound, such as CaO or Ca(OH)₂, is added to the separated liquid phase, which leads to an increase in the pH value. The advantage of this embodiment is that such compounds are usually available at low cost and, if necessary, at least a proportion of Ca phosphates are formed during precipitation. Ca-phosphate compounds as precipitation products have a very good fertilizing effect. In another preferred embodiment, a potassium compound, such as KOH, is added to the separated liquid phase, which leads to an increase in the pH value. The advantage here is that potassium is an important nutrient for plants and the added potassium is separated from the solution at least proportionally with the precipitated phosphate separated in process step e). As a result, the precipitated phosphate contains potassium as an additional nutrient.

In another preferred embodiment, the precipitation of the dissolved phosphate is carried out by adding an iron and/or aluminum-containing component such as Fe/Al chloride, Fe/Al sulfate.

It is preferable that at least 80% of the previously dissolved phosphate is precipitated by the precipitation of the phosphate. In this range, economically viable phosphate recovery can already take place in this process stream A. The precipitation of more than 90% of the previously dissolved phosphate is particularly preferable. This significantly improves the economic operation of the process.

In process step e) of the proposed method, the precipitated phosphate is separated at least proportionally from at least part of the liquid phase. The separated liquid phase is preferably returned at least in part to process step a) for the production of a raw material dispersion. The separated precipitated phosphate is at least proportionally fed to process step g) for the production of the fertilizer according to the invention.

The at least proportional separation of the precipitated phosphate within the meaning of the present invention can be carried out continuously and/or discontinuously in one or more steps, for example by filtration or centrifugation. For this purpose, for example, the processes and technologies listed there in process step c) for separation of the liquid phase can in principle be used.

Preferably, a resulting moisture content in the separated, precipitated phosphate is less than 60%. In a preferred embodiment, the moisture content after separation is less than 50%. The advantage of this embodiment is that a lower amount of physically bound water (moisture) is supplied to process step g), which is then separated from the fertilizer granules produced, preferably at high thermal cost, so that a desired low residual moisture in the fertilizer granules results.

In addition to the dissolved phosphate, the liquid phase fed to process step d) also contains other dissolved accompanying components. These accompanying components are converted into solution by the reaction between inorganic secondary phosphate and reactant with or simultaneously and are preferably not separated at least proportionally before process step d). Preferably, these accompanying components are at least partially separated with the precipitated phosphate in process e). For this purpose, the dissolved accompanying components can be precipitated with the phosphate or separately from it, at least proportionally, or precipitated specifically. Or they are separated at least proportionally with the physically bound water (moisture) adhering to the precipitated phosphate, in which they are dissolved. As a result, these accompanying components are at least proportionally transferred with the precipitated phosphate into the fertilizer in process stream B and do not accumulate as waste, which is a clear advantage of this embodiment.

If the preferred, at least partial return of the separated liquid phase to process step a) takes place over several cycles with constant process control, an equilibrium cycle with an equilibrium concentration of dissolved components is established in this partial cycle. The residual moisture adhering to the separated filter cake causes dissolved components to be discharged in accordance with the equilibrium concentration that has been reached.

In process step f) of the proposed method, a portion of the liquid phase is separated from the raw material dispersion produced in process step a) and fed to process stream B and then fed to process step h). The remaining residue from the solid and/or undissolved portion of the raw material suspension with the remaining portion of the liquid phase, which has not been separated, is fed to process step g).

The amount of liquid phase to be separated in this process step is selected according to the requirements of the subsequent granulation or extrusion in process step g) and/or the requirements of an optional at least partial heavy metal separation in process step h). For example, the type of granulation required determines the proportion of liquid phase to be separated.

In a particularly preferred embodiment, the moisture resulting from the partial separation of the liquid phase is from 10% to less than 40%. In other words, it is preferred in the sense of the invention that the moisture content is in a range between 10% and 40%. The advantage of such an adjusted moisture content is that a mixture with this moisture content (also referred to as an “earth-moist mixture”) can be granulated or extruded directly and relatively little liquid phase, for example in particular water, has to be evaporated to produce the fertilizer granules, in particular dry fertilizer granules. This saves considerable energy costs. In a particularly preferred embodiment, the resulting moisture content is set at 10% to less than 30%. The advantage of this embodiment of the invention is that a mixture with this moisture content can typically be granulated directly by means of granulating plates.

The partial separation of the liquid phase within the meaning of the present invention can be carried out continuously and/or discontinuously in one or more steps, for example by filtration or centrifugation. For this purpose, for example, the processes and technologies listed there in process step c) for separation of the liquid phase can in principle be used.

In the case of partial separation of the liquid phase, it is preferably not absolutely necessary that all solid components are completely separated from the separated liquid phase. In particular, very fine solid particles, which are preferably referred to as suspended particles in the sense of the invention, can preferably remain in the separated phase. On the one hand, this simplifies the separation process, for example during filtration or centrifugation, since the complete separation of fine particles in particular is very time-consuming in a solid-liquid separation with a high solid loading. On the other hand, these fine particles or suspended particles can be used advantageously in process step h) in the optional at least partial separation of the heavy metals, for example as nucleation or crystallization formers. However, if too high a proportion of undissolved solids gets into the separated liquid phase and thus into process step h), this can also be disadvantageous, for example if these introduced solids are separated with the heavy metals in process step h). High proportions of solids then increase the remaining heavy metal-containing residue. It is therefore preferable that the solids content of the separated liquid phase is less than 10%, particularly preferably less than 5% and very particularly preferably less than 2%.

In process step g), a mixture is produced from at least a portion of the precipitated phosphate produced in process stream A and separated in process step e) and at least a portion of the remaining raw material dispersion with reduced liquid phase from process step f), which is then fed to a granulation and/or extrusion process.

The mixing device for generating the mixture can be, for example, a mixing vessel with agitator, a roller mixer, which is preferably also referred to as a drop, drum or rotary mixer, a shear mixer, a compulsory mixer, a plow mixer, a planetary mixer, a Z-mixer, a sigma mixer, a fluid mixer or an intensive mixer. The selection of a suitable mixer depends in particular on the flowability and cohesive forces of the mix.

It is preferred in the sense of the invention that further components can be added to the mixture of precipitated phosphate separated in process step e) and the raw material dispersion with reduced liquid phase from process step f) before, during or after mixing. By specifically adjusting the type and composition of the resulting mixture as well as the type and intensity of mixing, it is advantageous to influence the reaction that is still ongoing and thus the neutral ammonium citrate solubility of the phosphate, but also other fertilizer properties.

In a particularly preferred embodiment of the invention, additional phosphate carriers are added as further components, for example ammonium phosphate, potassium phosphate, crystallization products from phosphorus elimination, such as struvite, brushite or hydroxyapatite-like Ca—P phase, are added in an amount such that this results in a fertilizer granulate with a total P₂O₅ content of greater than 35%, particularly preferably greater than 40%, and a neutral ammonium citrate-soluble phosphate content thereof of greater than 80%, particularly preferably greater than 90%. In another preferred embodiment of the invention, crystallization products from phosphorus elimination, such as struvite, brushite or hydroxyapatite-like Ca—P phase, are added in a range of 1 to 70%, based on the finished fertilizer granules according to the invention, in such a way such that this results in a nutrient or fertilizer granulate with a total P₂O₅ content of greater than 15%, a neutral ammonium citrate-soluble phosphate content of greater than 60% thereof and a water solubility of less than 30%, also based on the total P₂O₅ content. In a very particular embodiment of the invention, crystallization products from the phosphorus elimination are added in the range from 10 to 40%, based on the finished fertilizer granules according to the invention, whereby nutrient granules with a total P₂O₅ content of greater than 15%, with a neutral ammonium citrate-soluble phosphate content thereof, based on total P₂O₅, of greater than 85% and a water-soluble phosphate content, based on total P₂O₅, of less than 20%, in each case based on the composition of the nutrient granules.

Therefore, embodiments of the phosphate-enriched, heavy metal-depleted fertilizer granules (10) according to the invention and/or the method according to the invention are characterized in that at least one additional phosphate carrier selected from the group comprising ammonium phosphate, potassium phosphate and crystallization products from phosphorus elimination, such as struvite, brushite or hydroxyapatite-like Ca—P phase, is added in a range of 1 to 70%, based on the finished fertilizer granules according to the invention, brushite or hydroxyxlapatite-like Ca—P phase, is added in a range from 1 to 70%, based on the finished fertilizer granules according to the invention, in such a way that this results in fertilizer granules having a total P₂O₅ content of greater than 15%, a neutral ammonium citrate-soluble phosphate content of greater than 60% thereof and a water solubility of less than 30%, also based on the total P₂O₅ content.

Furthermore, one or more structural material(s) can be used as additional components, for example peat, humus, pyrolysis substrates from biomass, biochar from hydrothermal carbonization (HTC), but also sewage sludge, fermentation residues, liquid manure, animal excrements, animal and/or fish meal. For the purposes of the invention, the term “digestate” describes the liquid and/or solid residue that remains after the fermentation of biomass. For the purposes of the invention, the term “liquid manure” preferably describes a mixture of manure and urine from farm animals in combination with bedding with varying water content.

Therefore, embodiments of the phosphate-enriched, heavy metal-depleted fertilizer granules (10) according to the invention and/or the method according to the invention are characterized in that after process step f) and before and/or during granulation, at least one or more structural material(s) selected from the group comprising peat, humus, pyrolysis substrates from biomass, biochar (e.g. from hydrothermal carbonization (HTC)), sewage sludge, fermentation residues, manure, animal excrements, animal and fish meal are added as further components (13).

Depending on the type and concentration of this or these structural substance(s), the fertilizing effect can be adjusted and/or a soil-improving effect can be achieved when using the fertilizer granules. The fertilizing effect is preferably influenced by the fact that the structural properties of the fertilizer granules produced and thus their properties, such as the porosity, size of the pores, strength and/or solubility, can be adjusted by adding the structural material. This has the advantageous effect that, for example, the nutrient release can be specifically adapted to the plant growth and the time-dependent nutrient requirement of the plant. Another advantageous effect of this embodiment is a targeted soil improvement by adding a structural material to the fertilizer granules. For example, the structural material can lead to the formation of humus, to an improvement in the soil structure and/or to an improvement in the air and/or water balance of the soil when the fertilizer is used in agriculture. This can, for example, promote root growth, activate soil life and/or stimulate plant vitality against stress situations.

In some preferred embodiments of the method according to the invention or of the fertilizer granules according to the invention, the phosphate contained in the end product (fertilizer granules) originates solely from the recycling of the phosphates contained in the starting material (at least one inorganic secondary phosphate). According to the invention, it is preferred that no rock phosphates which have been conventionally mined (e.g., from natural deposits) are included in the fertilizer production method according to the invention or are contained in the fertilizer granules according to the invention. In other words, in embodiments, the fertilizer granules according to the invention do not comprise any conventionally mined rock phosphate/phosphate components. In embodiments, no conventionally mined rock phosphates/phosphate components are added to the method according to the invention. In embodiments, the phosphate obtained in the fertilizer granules according to the invention originates exclusively or essentially from the phosphates contained in the at least one inorganic secondary phosphate (starting material) and/or is converted therefrom and/or is obtained therefrom. In embodiments, the fertilizer granules according to the invention thus represent a (pure) phosphate recyclate. In embodiments, the method according to the invention thus serves to produce a (pure) phosphate recyclate.

Thus, the method according to the invention preferably offers the possibility of producing pure phosphate-recycled fertilizers with a higher phosphate content than that of the at least one incineration residue used, without the addition of conventional (conventionally obtained/degraded) phosphate-containing solvents or phosphate-containing nutrient components

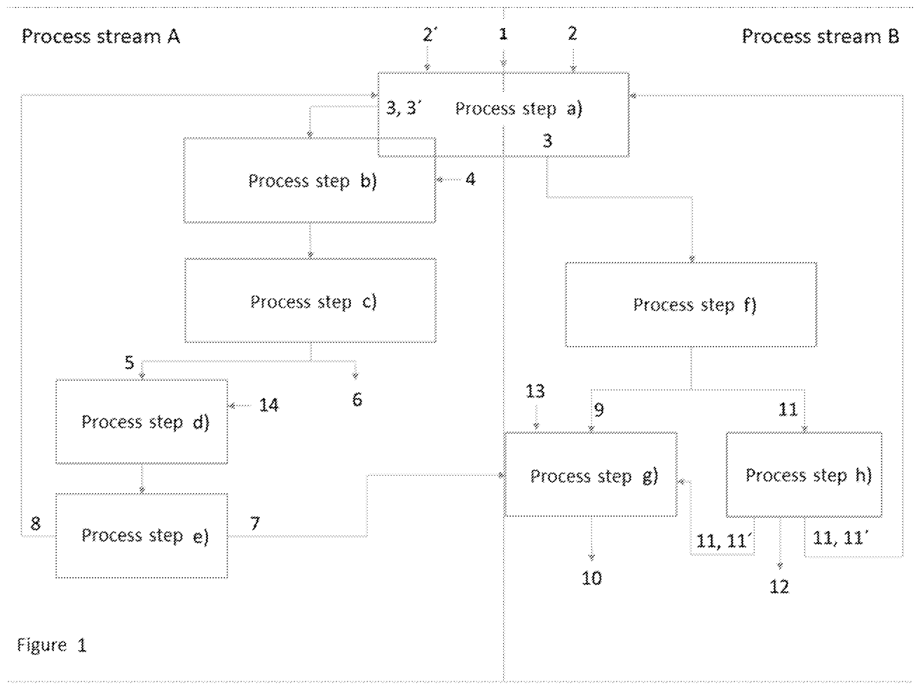

In a preferred embodiment of the invention, humic acid and/or fulvic acid and/or salts thereof (humates, fulvates) are added as a further component. Preferably, this further component (13) is added after process step f) and/or before and/or during granulation (see, for example, FIG. 1). These (nutrient) substances advantageously have growth-promoting properties. The nutrient absorption capacity of the root is significantly increased and thus stimulates growth. Their addition promotes plant growth and cell formation. They stimulate the cell membranes and metabolic activities, thereby increasing germination rates. Important plant enzymes are also particularly well stimulated. The strong root development supports the nutrient absorption capacity. Plants strengthened in this way are significantly less susceptible to disease. The addition of these substances can increase the P uptake of the plants, as it blocks the P adsorption of the soil and prevents the precipitation of P into poorly soluble compounds by complexing Ca, Al and Fe. Surprisingly, it was found that the addition of these substances in a range of 0.1-25% (based on the finished fertilizer granules according to the invention) results in a significant increase in the plant-available phosphate in the soil and thus an increased P uptake by the plants. The addition of these substances in a proportion of between 0.1 and 10% (based on the finished fertilizer granules according to the invention) is particularly preferable, since a considerable increase in the fertilizing effect is already achieved in this quantity range and consequently the amount of fertilizer required can be reduced accordingly by up to 40%. The addition of these substances in a quantity range of 0.1-5% (based on the finished fertilizer granules according to the invention) is particularly advantageous, since this range results in a particularly favorable economic ratio between the costs for these substances and the resulting improved properties.

In a further preferred embodiment of the invention, organic acids are added as a further component in solid and/or liquid form. Organic acids are, for example, ascorbic acid, acetic acid, formic acid, gluconic acid, malic acid, succinic acid, oxalic acid, tartaric acid and citric acid. Organic acids play an important role in the phosphate uptake of plants from the soil. In particular, the presence of organic acids at the root system allows plants to take up sufficient phosphate, with microorganisms typically producing these organic acids in the ecosystem. Surprisingly, it has now been found that the phosphate uptake of the plants is increased if one or more organic acids are already integrated proportionally in the fertilizer granules supplied, preferably in total in a range of 0.1 to 30% (based on the finished fertilizer granules according to the invention). It is assumed that these organic acids added to the fertilizer preferably directly assume a comparable function in the root area of the plant without these organic acids first having to be produced by microorganisms. Citric acid, oxalic acid and/or tartaric acid are preferably used individually or in combination, as these organic acids are relatively inexpensive and available in sufficient quantities. The use of citric acid, oxalic acid and tartaric acid individually or in combination in a quantity range of 0.1% to 10% (based on the finished fertilizer granules according to the invention) is particularly preferred, since the absorption-improving effect of these acids is particularly favorable here in relation to the raw material costs. The listed proportions of organic acids in the fertilizer granules can either be added as an additional component and/or, if organic acids are used as reactants, be present after the reaction (at least proportionally further in this quantity range) and thus be transferred to the fertilizer granules.

Agents for adjusting the pH value, such as alkalis, hydroxides, basic salts, ammonia or burnt lime, can also be added as additional components. In this way, any acid residues still present, for example when acids are used or formed, can be neutralized and/or the pH value of the fertilizer produced can be specifically adjusted.

The substances used, such as inorganic secondary phosphate, other components, can be ground individually, in combination or the mixture produced in process step g). This is advantageous, for example, if the particle or aggregate size of individual or several input materials is not fine enough, for example to achieve sufficient homogeneity, or if this can lead to process-related difficulties, such as clogging. This can be advantageously improved by reducing the particle or aggregate size. The solubility of substances or contained compounds can also be improved, for example the solubility of phosphate-containing ashes or slags. Depending on the type of material to be ground and the desired particle size and particle size distribution, different dry or wet grinding technologies can be used with or without grinding aids. The units used for dry or wet grinding can be, for example, ball mills, pin mills, jet mills, bead mills, agitator ball mills, high-performance dispersers and/or high-pressure homogenizers.

The pelletizing or extrusion can preferably take place during the production of the mixture and/or afterwards, for example in the same mixing device or in a separate pelletizing or extrusion unit, which is formed, for example, by pelletizing or granulating plates, granulating drums or extruders.

It is preferred in the sense of the invention that the proportion of the liquid phase not separated in process step b) and thus remaining with the solid in this process step has a considerable influence on the reactions taking place, the type of granulation, the product quality and/or the cost-effectiveness of the process. The total proportion of the liquid phase before granulation and/or extrusion can be adjusted, for example, via the process control in process step f) and the type and amount of liquid, moist or dry components added in process step g). If necessary, partial drying can also be carried out before granulation, for example to adjust the total proportion of the liquid phase before granulation and/or extrusion.

In a preferred embodiment of the invention, the raw material dispersion in process step c) or the moist solid is or is adjusted such that it contains a moisture content of less than 30%, preferably less than 25% and particularly preferably less than 20%. The preferably earth-moist mixture can preferably be granulated and/or extruded directly. In addition, relatively inexpensive granulation and/or extrusion processes or technologies, such as roller mixers, shear mixers, plow mixers, planetary mixers, intensive mixers and/or extrusion processes can be used. The tackiness required for granulation can preferably also be adjusted using different substances, such as binders. These can be added additionally, for example. The advantage of this preferred embodiment of the invention is that good roundness of the granules is achieved in the preferred granule size range and the granulation technology and process costs are favorable to use.

For the purposes of the invention, it is preferred that fertilizer granules have a low moisture content, i.e. physically bound water. In particular, it is preferred that a moisture content is in a range of less than 5%, preferably less than 2%. For the purposes of the invention, it may be preferred that the granules produced are dried or at least additionally post-dried after granulation and/or extrusion. Various drying technologies are available for this purpose, for example contact dryers, in which the thermal energy required for drying is preferably supplied by contact with heating surfaces, convective dryers, in which the thermal energy required for drying is preferably supplied by contact with hot gas or radiation dryers, in which the thermal energy required for drying is preferably supplied by radiation at a defined frequency. The drying process separates the liquid phase present, for example the water, to the required extent. Preferably, drying also increases the strength of the granules, for example by forming binding phases as a result of drying or, for example, by allowing a binding agent to develop its binding effect.

If crystallization products from the phosphorus elimination, such as struvite, brushite and/or hydroxyapatite-like Ca—P phase, are added to the raw material mixture and are consequently contained in the granules or green granules produced, it is preferred in the sense of the invention that the drying takes place above 100° C. relative to the material temperature during drying in a preferred embodiment of the invention. These crystallization products preferably contain a large proportion of chemically bound water, whereby this is preferably not “moisture” in the sense of the invention, but water which is present bound in the crystal structure. In the range above 100° C., this chemically bound water is preferably split off. Separating the water from the granules advantageously increases the percentage of the remaining components. For example, the concentration of nutrients in the granules, which were previously diluted by the chemically bound water, can be increased. In a particularly preferred embodiment of the invention, drying takes place when crystallization products from phosphorus elimination are contained in a range of 100-140° C. relative to the material temperature during drying. It is therefore particularly preferred in the sense of the invention that drying takes place in a temperature range between 10° and 140° C. Above 140° C., there is a risk that nitrogen is increasingly split off.

In terms of the invention, it is preferable that the fertilizer granules can be produced as accurately as possible. A size of the granules that is as uniform as possible advantageously ensures defined, uniform disintegration properties, which is necessary for a targeted nutrient supply. Furthermore, since the presence of oversized and undersized particles can impair the mechanical application of the fertilizer, it is preferable in the sense of the invention that oversized and undersized particles can be separated from the good particles and, if necessary, returned to the production process, in particular the mixing and/or granulation process, if necessary with prior preparation and/or grinding. For the purposes of the invention, the term “good grain” preferably describes a granulate in a desired size range for the granules. For the purposes of the invention, the terms “oversized” and “undersized” preferably describe granules which have-preferably significantly-larger or smaller diameters than the good granules.

The fertilizer granules produced according to the invention can be given one or more coatings for functionalization (e.g. reducing the tendency to clump, increasing the strength), for protection (e.g. against moisture) and/or for controlled nutrient release (influencing the solubility by the coating). Numerous methods and technologies for coating are known to the skilled person, whereby all methods and technologies that produce a desired coating with the desired functionality are suitable here.

The fertilizer granules produced according to the invention can be used for nutrient supply in agriculture, forestry and/or horticulture, wherein the fertilizer granules comprise at least one inorganic secondary phosphate and a greater than 60% neutral ammonium citrate-soluble P₂O₅ content. The fertilizer granulate produced according to the invention can preferably be used for nutrient supply in agriculture, forestry and/or horticulture, wherein the fertilizer granulate has a higher phosphate concentration compared to the inorganic secondary phosphate(s) (1) supplied, as well as a greater than 60% neutral ammonium citrate-soluble P₂O₅ content (than the inorganic secondary phosphate(s) (starting material)). It is particularly preferred in the sense that the proposed fertilizer granules can be used in agriculture, forestry and/or horticulture.

In process step h) of the proposed method, the liquid phase at least partially separated in process step f) is returned to process step a) for the production of a raw material dispersion or g) for granulation, whereby at least partial heavy metal separation can optionally take place. Whether and to what extent heavy metals have to be separated depends, for example, on the heavy metal contamination of the raw materials used, the legal requirements and the desired sustainability claim of the products produced.

Prior to the possible heavy metal separation, either the raw material dispersion in process step a) or f) and/or the separated liquid phase can be conditioned. Such conditioning can include in particular those measures that enable, improve and/or favor heavy metal separation in process step h), for example a targeted adjustment of the pH value, the precipitation or separation of interfering accompanying and/or nutrient elements or setting a defined concentration, viscosity and/or temperature.

Various processes are available for the possible separation of the heavy metal ions from the partially separated liquid phase, for example by means of an ion exchanger, liquid-liquid separation, activated carbon, bacteria, fungi, algae, a biomass of bacteria, fungi or algae, a precipitating agent, by nano-filters and/or electrolytically. Depending on the composition and conditioning of the liquid phase, the processes for heavy metal separation are suitable in different ways and are preferably selected accordingly. The process used is also selected according to which type of heavy metal is to be separated and in which concentration. This can be determined, for example, by which undesirable types of heavy metals are present in the inorganic secondary phosphate and how much of these are to be separated. The selected heavy metals also do not have to be completely separated; partial separation may be sufficient to obtain the desired heavy metal concentration in the fertilizer granulate produced, for example below the limit values of the applicable fertilizer ordinance. In another preferred embodiment of the invention, selective heavy metal separation by hydroxide precipitation is achieved by increasing the pH value. In another preferred embodiment of the invention, the selective heavy metal separation is carried out by sulfide precipitation by adding, for example, H₂S, CH₄N₂S, Na₂S.

In principle, the liquid phase partially purified or not purified from the heavy metals can be disposed of as a whole or in parts or can be supplied to another use. It is preferred in the sense of the invention that the liquid phase separated in process step f) is at least partially fed to process step a) and/or process step g). In process step a), the liquid phase serves in particular to adjust the solids/liquid ratio and preferably replaces the above-mentioned water content in the formulation of the raw material dispersion in an equivalent amount. In process step g), the liquid phase can be used for granulation/extrusion or for adjusting the moisture of the mixture for granulation or extrusion.

The liquid phase separated in process step f) contains dissolved components, for example due to the reaction between inorganic secondary phosphate and reactant. If this liquid phase with the dissolved components is at least partially recycled in process step a) with continuous process control, an equilibrium cycle with an equilibrium concentration of dissolved components is established in this partial cycle.

In a preferred embodiment of the invention, the liquid phase separated in process step f) and partially purified or non-purified from the heavy metals is returned at least proportionally to process step a). In this process, the required reactant or reactants are already added at least partially to the liquid phase before or during the return to process step a) and thus the liquid phase is transferred to process step a) together with at least the proportionate reactant. If the reactant or reactants are acids, for example, the pH value can advantageously be lowered by adding the reactant, thereby reducing precipitation or crystallization of dissolved components from the liquid phase until recirculation to process step a).

In a further aspect, the invention also relates to an apparatus for producing the phosphate-enriched, heavy metal-depleted fertilizer granules (10) according to the invention. In preferred embodiments, the apparatus according to the invention comprises a first unit:
either at least one first mixing container for feeding and/or mixing at least the inorganic secondary phosphate (1) and the reactant (2), whereby a raw material dispersion is obtained, wherein either the first mixing container is used for the incubation time and/or further containers are present into which the raw material dispersion is transferred and mixed for the incubation time, and subsequently a device for dividing the raw material dispersion produced into process streams A and B or a unit for dividing the at least one inorganic secondary phosphate (1) into process streams A and B, at least one mixing container for feeding and/or mixing at least the respectively divided inorganic secondary phosphate (1) and the reactant (2) for producing a raw material dispersion being connected thereto, whereby either the mixing container is used for the incubation time and/or further containers are present in which the raw material dispersion is transferred and mixed for the incubation time, and also comprehensively in process stream A
at least one mixing container at least for feeding the divided raw material dispersion in process stream A and the at least one heavy metal precipitation agent (4),
at least one separation unit for separating at least part of the phosphate-containing, heavy-metal-poor liquid phase (5) of the raw material dispersion and for discharging the remaining heavy-metal-containing filter cake (6) from the process, whereby the separating unit is integrated into the above mixing container or is separate from it,
at least one reaction vessel in which the precipitation of phosphate (7) from the phosphate-containing liquid phase (5) takes place at least proportionally,
at least one separation unit for separating at least a part of the precipitated phosphate (7), wherein are integrated and/or separately connected thereto
   at least one recirculation unit for the separated liquid phase (8) to the mixing container for producing a raw material dispersion analogous to process step a) and/or to the granulation and/or extrusion unit analogous to process step g), and
   at least one transfer unit for the separated precipitated phosphate (7) to the pelletizing and/or extrusion unit analogous to process step g), and
in process stream B
at least one separation unit for separation of at least part of the liquid phase (3),
at least one granulating and/or extruding unit for granulating and/or extruding at least a part of the precipitated phosphate (7) produced in process stream A and at least a part of the remaining raw material dispersion with reduced liquid phase (9) from process step f),
   wherein further components (13) can be fed into this granulation and/or extrusion unit and/or the mixture can be mixed,
   wherein at least one feed unit is provided from the separation unit for transferring the raw material dispersion to the pelletizing and/or extrusion unit,
at least one recirculation unit for the separated liquid phase (11, 11′) without heavy metal separation, or after partial separation of the heavy metals (12), to the mixing container for the production of a raw material dispersion analogous to process step a), and/or to the granulation and/or extrusion unit.

In one embodiment, apparatus for producing the phosphate-enriched, heavy metal-depleted fertilizer granules (10) according to the invention, comprising a first unit either at least one first mixing container for feeding and/or mixing at least the inorganic secondary phosphate (1) and the reactant (2), whereby a raw material dispersion (3) is obtained, wherein either the first mixing container is used for the incubation time and/or further containers are present into which the raw material dispersion is transferred and mixed for the incubation time and then a device for dividing the raw material dispersion (3) produced into process streams A and B, at least one further mixing container with at least one feed and at least one mixing unit for feeding and mixing at least the divided raw material dispersion (3) and at least one heavy metal precipitation agent (4) being connected thereto in process stream A. or a unit comprising a device for dividing the at least one or more inorganic secondary phosphates (1) or the mixture of several inorganic secondary phosphates (1) into process streams A and B,
wherein at least one mixing container for feeding and/or mixing at least the respectively divided inorganic secondary phosphate (1) and the reactant (2), whereby a raw material dispersion (3, 3′) is obtained in each case, is connected thereto in process stream A and B, wherein either the mixing container is used for the incubation time and/or further containers are present in which the raw material dispersion (3, 3′) is transferred and mixed for the incubation time,
wherein at least one feed of the at least one heavy metal precipitation agent (4) for feeding and mixing the at least one heavy metal precipitation agent (4) with the raw material dispersion (3′) is present in at least one of these mixing containers in process stream A and/or at least one further mixing container with at least one feed of the raw material dispersion (3′) and at least one heavy metal precipitation agent (4) is connected thereto,
and also comprehensively in process stream A
at least one separation unit for separation of at least part of the phosphate-containing, heavy metal-poor liquid phase (5) of the raw material dispersion (3, 3′) and for discharge of the remaining heavy metal-containing filter cake (6) from the process, wherein the separation unit is integrated in the above mixing vessel or is separate therefrom,
at least one reaction vessel in which the precipitation of phosphate (7) from the phosphate-containing liquid phase (5) takes place at least proportionally,
at least one separation unit for separation of at least a part of the precipitated phosphate (7), wherein
   at least one recirculation unit for the separated liquid phase (8) to the mixing container for producing a raw material dispersion (3, 3′) analogous to process step a) and/or to the granulating and/or extruding unit analogous to process step g), and
   at least one transfer unit for the separated precipitated phosphate (7) to the pelletizing and/or extrusion unit analogous to process step g)
are integrated and/or connect to it separately, and
in process stream B
at least one separation unit for separation of at least part of the liquid phase (3),
at least one granulating and/or extruding unit for granulating and/or extruding at least a part of the precipitated phosphate (7) produced in process stream A and at least a part of the remaining raw material dispersion with reduced liquid phase (9) from process step f),
wherein further components (13) can be fed into this granulation and/or extrusion unit and/or the mixture can be mixed, wherein at least one feed unit is provided from the separation unit for transferring the raw material dispersion (9) to the pelletizing and/or extrusion unit,
at least one recirculation unit for the separated liquid phase (11, 11′) without heavy metal separation or after partial separation of the heavy metals (12) to the mixing container for producing a raw material dispersion (3, 3′) analogous to process step a) and/or to the granulation and/or extrusion unit.

A preferred embodiment of the apparatus for the production of the phosphate-enriched, heavy metal-depleted fertilizer granules (10) according to the invention comprises a first unit

either at least one first mixing container for feeding and/or mixing at least the inorganic secondary phosphate (1) and the reactant (2), whereby a raw material dispersion (3) is obtained, wherein either the first mixing container is used for the incubation time and/or further containers are present into which the raw material dispersion is transferred and mixed for the incubation time and then a device for dividing the raw material dispersion (3) produced into process streams A and B, at least one further mixing container with at least one feed and at least one mixing unit for feeding and mixing at least the divided raw material dispersion (3) and at least one heavy metal precipitation agent (4) being connected thereto in process stream A.
or a unit comprising a device for dividing the at least one or more inorganic secondary phosphates (1) or the mixture of several inorganic secondary phosphates (1) into process streams A and B,
   wherein at least one mixing container for feeding and/or mixing at least the respectively divided inorganic secondary phosphate (1) and the reactant (2), whereby a raw material dispersion (3, 3′) is obtained in each case, is connected thereto in each case in process stream A and B, wherein either the mixing container is used for the incubation time and/or further containers are present in which the raw material dispersion (3, 3′) is transferred and mixed for the incubation time,
   wherein at least one feed of the at least one heavy metal precipitation agent (4) for feeding and mixing the at least one heavy metal precipitation agent (4) with the raw material dispersion (3′) is present in at least one of these mixing containers in process stream A and/or at least one further mixing container with at least one feed of the raw material dispersion (3′) and at least one heavy metal precipitation agent (4) is connected thereto,
and furthermore comprehensively in process stream A
at least one separation unit for separation of at least a part of the phosphate-containing, heavy metal-poor liquid phase (5) of the raw material dispersion (3, 3′) and for discharge of the remaining heavy metal-containing filter cake (6) from the process, wherein the separation unit is integrated into the above mixing vessel or is separate therefrom,
at least one reaction vessel in which the precipitation of phosphate (7) from the phosphate-containing liquid phase (5) takes place at least proportionally,
at least one separation unit for separation of at least a part of the precipitated phosphate (7), wherein
   at least one recirculation unit for the separated liquid phase (8) to the mixing container for producing a raw material dispersion (3, 3′) analogous to process step a) and/or to the granulating and/or extruding unit analogous to process step g), and
   at least one transfer unit for the separated precipitated phosphate (7) to the pelletizing and/or extrusion unit analogous to process step g)
      are integrated and/or connect to it separately, and
in process stream B
at least one separation unit for separation of at least part of the liquid phase (3),
at least one granulating and/or extruding unit for granulating and/or extruding at least a part of the precipitated phosphate (7) produced in process stream A and at least a part of the remaining raw material dispersion with reduced liquid phase (9) from process step f),
wherein further components (13) can be fed into this granulation and/or extrusion unit and/or the mixture can be mixed,
wherein at least one feed unit is provided from the separation unit for transferring the raw material dispersion (9) to the pelletizing and/or extrusion unit,
at least one recirculation unit for the separated liquid phase (11, 11′) without heavy metal separation or after partial separation of the heavy metals (12) to the mixing container for producing a raw material dispersion (3, 3′) analogous to process step a) and/or to the granulation and/or extrusion unit.

In a further aspect, the invention also relates to the use of the phosphate-enriched, heavy metal-depleted fertilizer granules (10) according to the invention for nutrient supply in agriculture, forestry and/or horticulture. In preferred embodiments, this use according to the invention is characterized in that the phosphate-enriched, heavy metal-depleted fertilizer granulate (10) comprises at least one inorganic secondary phosphate (1), as well as a greater than 60% neutral ammonium citrate-soluble P₂O₅ content. In a further preferred embodiment, use according to the invention is characterized in that the phosphate-enriched, heavy metal-depleted fertilizer granulate (10) has a higher phosphate concentration than in comparison with the inorganic secondary phosphate(s) (1) supplied and a greater than 60% neutral ammonium citrate-soluble P₂O₅ content.

In one embodiment of the use of the phosphate-enriched, heavy metal-depleted fertilizer granules (11) according to the invention, this comprises use for nutrient supply in agriculture, forestry and/or horticulture, characterized in that the phosphate-enriched, heavy metal-depleted fertilizer granules (10) have a higher phosphate concentration than the inorganic secondary phosphate(s) (10) supplied, heavy metal-depleted fertilizer granulate (10) has a higher phosphate concentration than in comparison with the inorganic secondary phosphate(s) (1) supplied, as well as a greater than 60% neutral ammonium citrate-soluble P₂O₅ content.

### EXAMPLES

The invention is described in more detail with reference to the following embodiment example. Further advantages, features and details of the invention can be seen from the further sub-claims and the specification. The features mentioned there may be essential to the invention either individually or in any combination. Thus, the disclosure can always be referred to the individual aspects of the invention alternately.

### Design Example 1

In a mixing tank, 200 kg of water and 50 kg of sulphuric acid (95%) are added as reactant and mixed, 100 kg of sewage sludge ash (P₂O₅ content 19.0%, of which 38% is neutral ammonium citrate soluble and <1% water soluble) is added as inorganic secondary phosphate and the resulting raw material dispersion is mixed. The inorganic secondary phosphate contains 75 mg/kg Pb, 65 mg/kg Ni, 14 mg/kg As and 2 mg/kg Cd. An incubation time of 30 minutes is observed so that the inorganic secondary phosphate can react with the reactant to a sufficient extent. After the incubation time, 280 kg of the raw material dispersion produced in this way is fed to process step b) in process stream A and 70 kg of the raw material dispersion produced in this way is fed to process step f) in process stream B.

In the raw material dispersion fed to process step b), 3% of the Pb, 8% of the Ni, 91% of the As, 75% of the Cd and 98% of the P fed with the inorganic secondary phosphate process stream B are dissolved. In process step b), 1 kg of sodium sulfide is added to the raw material dispersion and an incubation time in the sense of a reaction time between the heavy metal precipitation agent sodium sulfide and the raw material dispersion. After the incubation time, 2% of the Pb, 8% of the Ni, 5% of the As, 7% of the Cd and 95% of the P added with the inorganic secondary phosphate are still dissolved.

This conditioned raw material dispersion is fed into a solid-liquid separation process using a membrane filter press. Using a membrane filter press, a large part of the liquid phase is separated from the solid in such a way that 105 kg of heavy metal-containing filter cake is formed as a solid mixture with a moisture content of 40%. This filter cake containing heavy metals is discharged from the process. In addition, the solid-liquid separation produces a phosphate-containing, low heavy metal liquid phase, which is fed to process step d).

The pH value of the separated phosphate-containing, heavy metal-poor liquid phase is adjusted to 3 by adding CaO. Due to the increase in pH value, a large part of the phosphate precipitates, whereby only 5% of the P added with the inorganic secondary phosphate process stream B is still dissolved. This is followed by solid-liquid separation using a membrane filter press, whereby the precipitated phosphate is separated and fed to process step g) in process stream B. In addition to 35% P₂O₅ as phosphate, the precipitated phosphate contains 25% of separated accompanying substances from the sewage sludge ash (such as Al, Mg, Fe, K oxide (hydrates/hydroxides)). These accompanying substances are processed with the precipitated phosphate in process stream B to form fertilizer granulates. The separated (low-phosphate) liquid phase is completely fed into the next batch for the production of a raw material dispersion (process step a)).

In process step f), the 70 kg of the raw material dispersion fed in is subjected to solid-liquid separation using a membrane filter press, forming an earth-moist filter cake with 28% residual moisture. The separated liquid phase is fed to process step a) without heavy metal depletion for the production of the next batch of raw material dispersion.

In process step g), the separated earth-moist filter cake is homogeneously mixed with the precipitated phosphate formed in process stream A and then granulated. The green granules formed in this way are then dried at 110° C. and fractionated into granules with diameters between 2 and 5 mm. The fraction of granules with a diameter smaller than 2 mm and the fraction of granules with a diameter larger than 5 mm are recycled after prior grinding of the granulation.

The 61 kg granulate produced in this way, with a residual moisture content of 5%, has a round and compact granulate shape in the range 2-5 mm, a total P₂O₅ content of 25%, of which 93% is ammonium citrate-soluble and 15% is water-soluble, after adjustment of the equilibrium cycles described above. The fertilizer granulate produced contains 32 mg/kg Pb, 16 mg/kg Ni, 3 mg/kg As and 0.4 mg/kg Cd. The process stream A thus separates not only more than 75% of As and Cd as examples of heavy metals well dissolved by the reactant, but also more than 75% of Pb and Ni as examples of heavy metals very poorly dissolved by the reactant.

### Design Example 2

Analogous to embodiment example 1, a raw material dispersion is produced. The resulting phosphate enrichment and heavy metal depletion in the fertilizer granulate can be adjusted by selectively controlling the partial material flows of the raw material dispersion supplied for process stream A or B. In embodiment 2, after the incubation time, 140 kg of the raw material dispersion produced in this way is fed to process step b) in process stream A and 210 kg of the raw material dispersion produced in this way is fed to process step f) in process stream B.

The process steps b) to h) are carried out analogous to embodiment example 1 only with the changed quantity ratios analogous to the changed distribution of the raw material dispersion.

Process step g) results in 105 kg of fertilizer granulate with a residual moisture content of 5% and a total P₂O₅ content of 17%, of which 94% is ammonium citrate-soluble and 17% is water-soluble. The fertilizer granulate produced in this way contains 82 mg/kg Pb, 42 mg/kg Ni, 8 mg/kg As and 1.1 mg/kg Cd. The process thus separates not only more than 35% of As and Cd as examples of heavy metals well dissolved by the reactant, but also more than 35% of Pb and Ni as examples of heavy metals very poorly dissolved by the reactant.

The heavy metal depletion in this embodiment example is thus lower than in embodiment example 1. In return, this embodiment example produces significantly less filter cake containing heavy metals, with only 52.5 kg (basically waste). A much larger proportion of the non-phosphate components is transferred from the inorganic secondary phosphate into the fertilizer, which produces a larger amount of fertilizer with a lower phosphate concentration.

The invention is specified in more detail with reference to the following figures. FIGS. 1 to 3 each show a schematic representation of preferred embodiments of the proposed method in embodiments.

FIG. 1 describes a preferred embodiment of the proposed two-strand process (comprising stream A and stream B). The preferred embodiment shown at essentially makes full use of the process engineering advantages of the proposed two-strand process, which proportionally converts a heavy metal-containing inorganic secondary phosphate into a phosphate-enriched, heavy metal-depleted fertilizer granulate, whereby the very poorly plant-available phosphate is converted from the secondary phosphate into a very good plant-available phosphate.

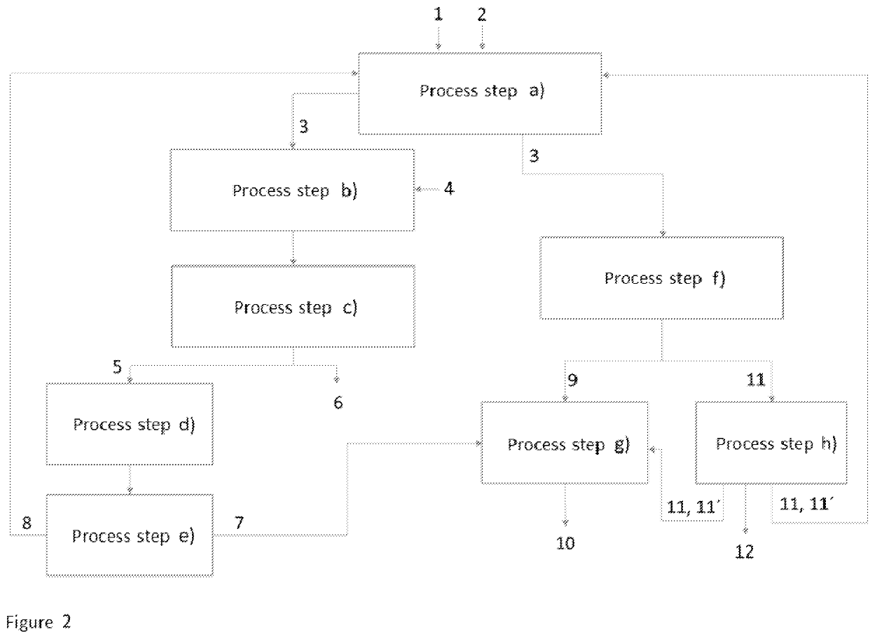

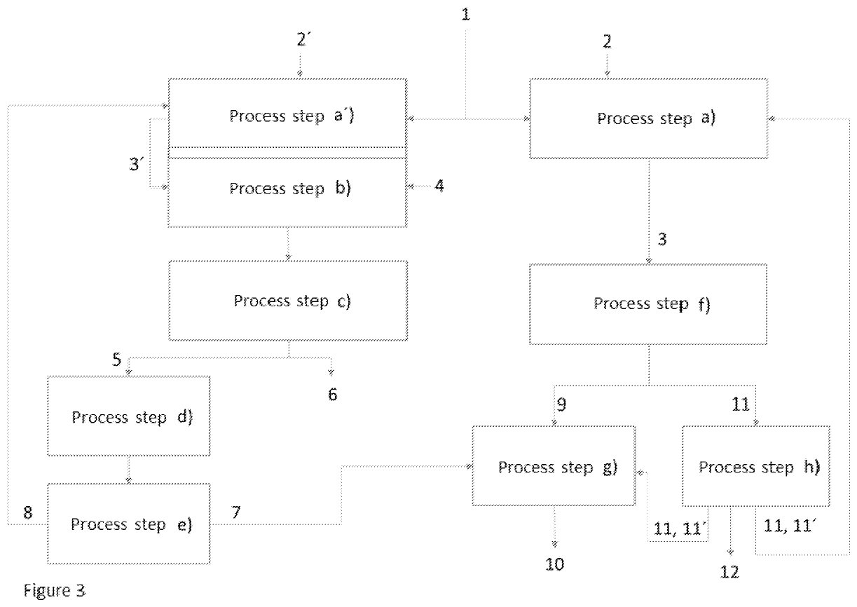

In process step a), a raw material dispersion (3, 3′) is produced and provided for the two process streams A (left; steps b) to g)) and B (right; steps f) to g)/h)). For this purpose either a common raw material dispersion (3) is first produced in a suitable vessel and this raw material dispersion (3) produced in this way is then fed separately to process stream A and process stream B (FIG. 2 describes this embodiment) or the inorganic secondary phosphate (1) is first divided and thus two separate raw material dispersions (3, 3′) are produced, with one raw material dispersion (3′) then being fed to process stream A and the other raw material dispersion (3) being fed to process stream B (see FIG. 3 for a description of this embodiment).

The raw material dispersion (3, 3′) is produced from at least one inorganic secondary phosphate (1) and at least one reactant (2). An incubation time is waited for sufficient reaction between the at least one reactant (2) and the at least one inorganic secondary phosphate (1), whereby the raw material dispersion (3, 3′) can be further mixed. It is envisaged that the reactant (2) reacts with at least parts of the phosphate introduced by the inorganic secondary phosphate (1) in order thereby to increase the solubility and plant availability of this phosphate.

The preferred embodiment shown essentially fully utilizes the process engineering advantages by producing the raw material dispersion according to the invention with a high liquid phase content. In contrast to prior art processes, a raw material dispersion with a high liquid phase content is first produced, whereby the high liquid phase content advantageously acts as a buffer for the reaction taking place. As a result, the often spontaneous and sometimes very exothermic reactions that occur when mixing the phosphate-containing secondary raw material with the mineral acid can be monitored and controlled and the mixture does not exhibit any disruptive stickiness. Only after the reaction between the inorganic secondary phosphate (1) and the reactant (2) has largely taken place does further processing take place until the granulate is obtained. The phosphate conversion reaction is thus advantageously separated from the granulation process.

The raw material dispersion (3, 3′), which is fed to process step b) (process stream A), should be conditioned in such a way that the phosphate from the at least one inorganic secondary phosphate (1) is largely present in dissolved form, preferably with a proportion greater than 80%. In process step b), a heavy metal precipitation agent is added to this thus conditioned raw material dispersion (3, 3′). The heavy metal precipitation agent is intended to precipitate at least some of the dissolved heavy metals contained in the raw material dispersion (3, 3′). Dissolved heavy metals result in the raw material dispersion, for example, in that the reaction between the at least one reactant (2) and the at least one inorganic secondary phosphate (1) also at least partially dissolves the heavy metals contained in the inorganic secondary phosphate.

In process step c), part of the liquid phase is separated from the raw material dispersion (3, 3′) conditioned in process step b) as a phosphate-containing liquid phase (5) low in heavy metals and fed to process step d). Preferably, the process is controlled in such a way that the separated phosphate-containing, heavy metal-poor liquid phase (5) contains at least 70% of the phosphate added to the raw material dispersion (3, 3′) with the inorganic secondary phosphate (1). The remaining heavy metal-containing filter cake (6) from the solid or undissolved portion of the raw material suspension (3, 3′) with the remaining portion of the liquid phase (residual moisture) is discharged from the process. Due to the heavy metal precipitation in process step b), these precipitated heavy metals are contained in the separated heavy metal-containing filter cake (6).

In process step d), a precipitation additive (14) is added to the phosphate-containing, heavy metal-poor liquid phase (5). This precipitation additive converts at least part of the dissolved phosphate into a solid form. This precipitated phosphate is largely separated from the liquid phase in process step e), i.e. the precipitated phosphate (7) separated in this way still contains a proportion of residual moisture after the separation step. Preferably, the process is controlled such that the separated precipitated phosphate (7) contains at least 70% of the phosphate added to the raw material dispersion (3, 3′) with the inorganic secondary phosphate (1).

The separated liquid phase (8) is preferably returned to process step a) for the production of the raw material dispersion. Alternatively, this separated liquid phase (8) can also be at least partially discharged from the process and/or fed to the granulation in process step i).

In process step f) (process stream B), part of the liquid phase (11) is separated from the raw material dispersion (3) produced in process step a) and fed to process step h). The remaining raw material dispersion with reduced liquid phase (9) is fed to process step g). The proposed reaction sequence between inorganic secondary phosphate (1) and reactant (2) in a raw material dispersion with a high liquid phase content has, in particular, the process engineering advantages described. If the raw material dispersion is to be granulated directly, a very high proportion of water must be separated by, for example, drying, which is, however, cost-intensive. Accordingly, in the proposed process, part of the liquid phase is recirculated and separated mechanically before granulation and fed back into the production of the raw material dispersion.

In process step g), the remaining raw material dispersion with reduced liquid phase (9) from process step f) is combined with at least part of the precipitated phosphate (7) separated in process step e) and this mixture is granulated and/or extruded. Various granulation or extrusion processes can be used depending on the liquid/solid ratio set. Before and/or during granulation, further components (13), such as nutrient-containing components, dispersing and defoaming agents, structural substances, agents for pH adjustment, urease inhibitors, ammonium stabilizers and/or water, can be added, in particular to adjust a desired nutrient and/or active ingredient composition. At least part of the separated liquid phase (11, 11′) can also be used, for example, to adjust the solid/liquid ratio.

This process step g) results in a soil- and plant-specific, heavy metal-depleted fertilizer granulate (10) with a set and constant nutrient composition, whereby inorganic secondary phosphate (1) can be used as at least one nutrient source, such as sewage sludge ash, can be used as at least one nutrient source, the phosphate contained therein being made readily available to plants by the action of the reactant (2) and the heavy metals contained in the inorganic secondary phosphate (2) being at least partially separated.

In process step h), at least partial separation of heavy metals (12) from the liquid phase (11) separated in process step f) and discharge of these heavy metals (12) from the process can take place. Different processes can be used for separating the heavy metals, depending on the type and concentration of the heavy metals to be separated or the conditioning of the separated liquid phase from process step f). Depending on the type of separation process, additives are used for heavy metal separation, such as precipitants and flocculants, agents for pH adjustment, sacrificial metals and/or extraction agents. The separated liquid phase 11′) reduced in heavy metal content in this way or the separated liquid phase (11) without heavy metal separation is recycled in process step h) to produce a raw material dispersion analogous to process step a) and/or fed for granulation in process step g). Alternatively, at least part of the separated liquid phase (11) can also be discharged.

Process steps a) to h) can be repeated as often as required.

FIG. 2 shows a preferred embodiment of the proposed two-stream process (comprising stream A and stream B). Here, in process step a), a common raw material dispersion (3) is produced in a suitable vessel and this raw material dispersion (3) produced in this way is then fed to process stream A (left; steps b) to g)) and process stream B (right; steps f) to g)/h)) in divided form. The advantage of this embodiment is, for example, that the production of only one raw material dispersion is easier to handle, less complex in terms of process control and only one suitable reaction vessel is required for the production of the raw material dispersion (3).

Process steps b) to h) are essentially comparable to the embodiment of the invention shown in FIG. 1.

FIG. 3 shows another preferred embodiment of the proposed two-stream process (comprising stream A and stream B). Here, in process step a), the inorganic secondary phosphate (1) is first divided and thus two separate raw material dispersions (3, 3′) are produced, one raw material dispersion (3′) being fed to process stream A (left; steps a′) to g)) and the other raw material dispersion (3) being fed to process stream B (right; steps a) to g)/h)). The advantage of this is that the raw material dispersions 3 or 3′-produced in this way can be conditioned differently, adapted to the respective process stream. For example, different reactants (2, 2′), different proportions of liquid phase can be used or different reaction parameters such as pH value or incubation time can be selected in order to specifically adjust the dissolution and conversion reaction between inorganic secondary phosphate (1) and reactant (2).

Process steps b) to h) are essentially comparable to the embodiment of the invention shown in FIG. 1.

### LIST OF REFERENCE SIGNS

1 Inorganic secondary phosphate
2 Reactant
3, 3′ Raw material dispersion
4 Heavy metal precipitation agent
5 Phosphate-containing, low heavy metal liquid phase
6 Filter cake containing heavy metals
7 Precipitated phosphate
8 Separated liquid phase
9 Raw material dispersion with reduced liquid phase
10 Heavy metal-depleted fertilizer granules
11, 11′ Separated liquid phase
12 Heavy metals
13 Further components
14 Precipitation additive

1. A phosphate-enriched, heavy metal-depleted fertilizer granules (11) producible from at least one inorganic secondary phosphate (1) by a two-stream process, wherein a raw material dispersion (3, 3′) is fed to process stream A and process stream B, in which this raw material dispersion
either is produced in process step
a) from at least one inorganic secondary phosphate (1) and at least one reactant (2) and this produced raw material dispersion (3) is fed divided to process stream A and B
or in process step a), a′) the inorganic secondary phosphate (1) is first divided, two raw material dispersions (3, 3′) each comprising a partial amount of the at least one inorganic secondary phosphate (1) and at least one reactant (2, 2′) are produced separately from one another and these separately produced raw material dispersions (3, 3′) are fed to process streams A and B,
wherein the proportion of a liquid phase in the raw material dispersion (3, 3′) is greater than 30% and the incubation time between inorganic secondary phosphate (1) and reactant (2, 2′) is between 1 and 100 minutes,
where the process stream A comprises the following process steps,
b) addition of at least one heavy metal precipitation agent (4) during and/or after the incubation period,
c) separation of a part of the phosphate-containing, heavy metal-poor liquid phase (5) of the raw material dispersion and discharge of the remaining heavy metal-containing filter cake (6) from the process,
d) precipitation of phosphate (7) from the phosphate-containing liquid phase (5),
e) separation of the precipitated phosphate (7) and at least partial recycling of the separated liquid phase (8) to process step a) for the production of a raw material dispersion,
where the process stream B comprises the following process steps,
f) separation of part of the liquid phase of the raw material dispersion (3),
g) production of a mixture of at least a part of the precipitated phosphate (7) produced in process stream A and at least a part of the remaining raw material dispersion with reduced liquid phase (9) from process step f) and granulation and/or extrusion of this produced mixture, whereby drying or coating of the produced granulates and/or extrudates can take place and discharge of the produced phosphate-enriched, heavy metal-depleted fertilizer granulate (10) from the process,
h) at least partial recycling of the liquid phase (11, 11′) separated in process step f) for the production of a raw material dispersion analogous to process step a) and/or feeding into process step g), whereby at least partial separation of heavy metals (12) from the liquid phase separated in process step f) and discharge of these heavy metals (12) from the process can take place beforehand,
and repeat process steps a) to h).

2. A method for the production of a phosphate-enriched, heavy metal-depleted fertilizer granulate (11) from at least one inorganic secondary phosphate (1) by a two-stream process, wherein a raw material dispersion (3, 3′) is fed to process stream A and process stream B, in which this raw material dispersion
either is produced in process step
a) from at least one inorganic secondary phosphate (1) and at least one reactant (2) and this produced raw material dispersion (3) is fed divided to process stream A and B
or in process step a), a′) the inorganic secondary phosphate (1) is first divided, two raw material dispersions (3, 3′) each comprising a partial amount of the at least one inorganic secondary phosphate (1) and at least one reactant (2, 2′) are produced separately from one another and these separately produced raw material dispersions (3, 3′) are fed to process streams A and B,
wherein the proportion of a liquid phase in the raw material dispersion (3, 3′) is greater than 30% and the incubation time between inorganic secondary phosphate (1) and reactant (2, 2′) is between 1 and 100 minutes,
where the process stream A comprises the following process steps,
b) addition of at least one heavy metal precipitation agent (4) during and/or after the incubation period,
c) separation of a part of the phosphate-containing, heavy metal-poor liquid phase (5) of the raw material dispersion and discharge of the remaining heavy metal-containing filter cake (6) from the process,
d) precipitation of phosphate (7) from the phosphate-containing liquid phase (5),
e) separation of the precipitated phosphate (7) and at least partial recycling of the separated liquid phase (8) to process step a) for the production of a raw material dispersion,
where the process stream B comprises the following process steps
f) separation of part of the liquid phase of the raw material dispersion (3),
g) production of a mixture of at least a part of the precipitated phosphate (7) produced in process stream A and at least a part of the remaining raw material dispersion with reduced liquid phase (9) from process step f) and granulation and/or extrusion of this produced mixture, whereby drying or coating of the produced granulates and/or extrudates can take place and discharge of the produced phosphate-enriched, heavy metal-depleted fertilizer granulate (10) from the process,
h) at least partial recycling of the liquid phase (11, 11′) separated in process step f) for the production of a raw material dispersion analogous to process step a) and/or feeding into process step g), whereby at least partial separation of heavy metals (12) from the liquid phase separated in process step f) and discharge of these heavy metals (12) from the process can take place beforehand,
and repeat process steps a) to h).

3. The method according to claim 2, characterized in that the addition of the at least one heavy metal precipitation agent and the heavy metal precipitation are carried out at a pH value of less than 2 and the separation of part of the phosphate-enriched, heavy metal-depleted liquid phase (5) of the raw material dispersion and discharge of the remaining heavy metal-depleted filter cake (6) from the process also take place at a pH value of less than 2.

4. The method according to claim 2, characterized in that at least one added heavy metal precipitation agent is a sulfide.

5. The method according to claim 2, characterized in that at least one heavy metal precipitation agent is added during the incubation period.

6. The method according to claim 2, characterized in that more than 80% of the total heavy metals present in solution are precipitated from the raw material dispersion by the added at least one heavy metal precipitation agent (4), at least 80% of the P₂O₅ previously present in solution continuing to be present in solution in the raw material dispersion after the heavy metal precipitation.

7. The of method according to claim 2, characterized in that the phosphate-enriched, heavy metal-depleted fertilizer granules (10) have a phosphate concentration which is at least 30% higher than the inorganic secondary phosphate(s) supplied.

8. The method according to claim 2, characterized in that the phosphate-enriched, heavy metal-depleted fertilizer granulate (10) has a heavy metal concentration which is at least 20% lower in total than the inorganic secondary phosphate(s) supplied.

9. The method according to claim 2, characterized in that at least one additional phosphate carrier, selected from the group consisting of: ammonium phosphate, potassium phosphate and crystallization products from phosphorus elimination, selected from the group consisting of: struvite, brushite and hydroxylapatite-like Ca—P phase, is added in a range from 1 to 70%, based on the finished fertilizer granulate according to the invention, brushite and hydroxyapatite-like Ca—P phase, is added in a range from 1 to 70%, based on the finished fertilizer granules such that this results in fertilizer granules having a total P₂O₅ content of greater than 15%, a neutral ammonium citrate-soluble phosphate content of greater than 60% thereof and a water solubility of less than 30%, based on the total P₂O₅ content.

10. The method according to claim 2, characterized in that after process step f) and before and/or during granulation at least one or more structural material(s) selected from the group consisting of: peat, humus, pyrolysis substrates from biomass, biochar, sewage sludge, fermentation residues, liquid manure, animal excrements, animal meal and fish meal are added as further components (13).

11. The method according to claim 2, characterized in that humic acid and/or fulvic acid and/or salts thereof are added as a further component (13) after process step f) and before and/or during granulation.

12. An apparatus for producing the phosphate-enriched, heavy metal-depleted fertilizer granules (11) according to claim 1, comprising a first unit
either at least one first mixing container for feeding and/or mixing at least the inorganic secondary phosphate (1) and the reactant (2), whereby a raw material dispersion is obtained, wherein either the first mixing container is used for the incubation time and/or further containers are present into which the raw material dispersion is transferred and mixed for the incubation time, and subsequently a device for dividing the raw material dispersion produced into process streams A and B,
or a unit comprising a device for dividing the at least one inorganic secondary phosphate (1) into process streams A and B,
wherein at least one mixing container for supplying and/or mixing at least the respectively divided inorganic secondary phosphate (1) and the reactant (2), whereby a raw material dispersion is obtained, is connected thereto,
wherein either the mixing container is used for the incubation time and/or further containers are present in which the raw material dispersion is transferred and mixed for the incubation time,
and also comprehensively in process stream A
at least one mixing container at least for feeding the divided raw material dispersion in process stream A and at least one heavy metal precipitation agent (4),
at least one separation unit for separating at least part of the phosphate-containing, heavy-metal-poor liquid phase (5) of the raw material dispersion and for discharging the remaining heavy-metal-containing filter cake (6) from the process,
whereby the separating unit is integrated into the above mixing container or is separate from it,
at least one reaction vessel in which the precipitation of phosphate (7) from the phosphate-containing liquid phase (5) takes place at least proportionally,
at least one separation unit for separation of at least a part of the precipitated phosphate (7), wherein
at least one recirculation unit for the separated liquid phase (8) to the mixing container for producing a raw material dispersion analogous to process step a) and/or to the granulation and/or extrusion unit analogous to process step g), and
at least one transfer unit for the separated precipitated phosphate (7) to the pelletizing and/or extrusion unit analogous to process step g)
are integrated and/or connect to it separately, and
in process stream B
at least one separation unit for separation of at least part of the liquid phase (3),
at least one granulating and/or extruding unit for granulating and/or extruding at least a part of the precipitated phosphate (7) produced in process stream A and at least a part of the remaining raw material dispersion with reduced liquid phase (9) from process step f),
wherein further components (13) can be fed into this granulation and/or extrusion unit and/or the mixture can be mixed,
wherein at least one feed unit is provided from the separation unit for transferring the raw material dispersion to the pelletizing and/or extrusion unit,
at least one recirculation unit for the separated liquid phase (11, 11′) without heavy metal separation or after partial separation of the heavy metals (12) to the mixing container for producing a raw material dispersion analogous to process step a) and/or to the granulation and/or extrusion unit.

13. (canceled)

14. The method according to claim 11, characterized in that the salts of the humic acid and/or the fulvic acid are humates and fulvates, respectively.
